(19) United States
(12) Patent Application Publication
(10) Pub. No.: US 2026/0056381 A1
(43) Pub. Date: Feb. 26, 2026

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Wen-Shun LO, Zhudong Township (TW); Shang-Ying TSAI, Pingzhen City (TW); Chun-Heng CHEN, Hsinchu City (TW); Shao-Da WANG, New Taipei City (TW); Sheng Kai YEH, Taichung City (TW); Chi-Yuan SHIH, Hsinchu (TW); YingKit Felix TSUI, Cupertino, CA (US)

(21) Appl. No.: 18/810,962

(22) Filed: Aug. 21, 2024

(51) Int. Cl. G02B 6/42

(52) U.S. Cl. CPC G02B 6/4295; G02B 6/4213; G02B 6/4214; G02B 6/4215

(57) ABSTRACT

An optical demultiplexer circuit is configured to demultiplex a plurality of polarized optical signals using the same set of photonics components. A multiplexed optical signal may be split into two or more polarized optical signals, each carrying a plurality of data streams that are multiplexed onto different wavelength components. An optical resonator structure, an optical waveguide structure, and a photodetector structure of the optical demultiplexer circuit are configured to demultiplex a wavelength component from the two or more polarized optical signals, as opposed to having separate optical resonator structures for each of the two or more polarized optical signals. The two or more polarized optical signals may propagate along an optical waveguide loop in opposite directions toward the optical resonator structure and may optically couple to the waveguide structure through the optical resonator structure.

### BACKGROUND

A semiconductor photonics device may be configured to use optical signals for high speed and secure data transmission. Semiconductor photonics devices may be used in applications such as high-performance computing (HPC), high-speed telecommunications, data center communication, and/or optical sensing, among other uses.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example semiconductor photonics device described herein.

FIG. 2 is a diagram of an example of a portion of a semiconductor photonics device described herein.

FIG. 3 is a diagram of an example implementation of a cross-section view of a portion of a semiconductor photonics device described herein.

FIG. 4 is a diagram of an example implementation of optical signal propagation in a semiconductor photonics device described herein.

FIG. 5 is a diagram of an example of an input optical signal described herein.

FIG. 6 is a diagram of an example implementation of a portion of a wavelength component demultiplexing circuit described herein.

FIGS. 7A-7M are diagrams of an example implementation of forming a semiconductor photonics device (or a portion thereof) described herein.

FIG. 8 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a photonic integrated circuit of a semiconductor photonics device may include an optical demultiplexer circuit that is configured to demultiplex wave division multiplexed (WDM) optical signals. WDM enables an optical signal to carry a plurality of data streams that are multiplexed together on the optical signal using different optical wavelengths. In general, the greater the quantity of data streams that are multiplexed together on an optical signal, the greater the complexity of optical demultiplexer circuit that is needed to demultiplex the optical signal. For example, the optical demultiplexer circuit may include a set of photonics components (e.g., optical resonator structures, optical waveguide structures, photodetector structures) for each data stream that is multiplexed onto the optical signal. Thus, increasing the quantity of data streams that are multiplexed onto the optical signal increases the quantity of photonics components for demultiplexing the optical signal.

Moreover, the optical signal may be received as an unpolarized optical signal, and therefore the optical signal may need to be polarized into a plurality of polarized optical signals that each are demultiplexed by the optical demultiplexer circuit. This further increases the complexity of the optical demultiplexer circuit, and results in significant scaling complexity for added data streams. For example, each additional data stream that is multiplexed onto an optical signal may result in the addition of two or more sets of photonics components for two or more polarized optical signals. Thus, a data stream that is multiplexed onto an optical signal results in at least double the increase in power consumption and at least double the increase in physical size of the semiconductor photonics device.

In some implementations described herein, a photonic integrated circuit of a semiconductor photonics device includes an optical demultiplexer circuit that is configured to demultiplex a plurality of polarized optical signals using the same set of photonics components. For example, a WDM optical signal may be split into two or more polarized optical signals, each carrying a plurality of data streams that are multiplexed onto different wavelength components. An optical resonator structure, an optical waveguide structure, and a photodetector structure of the optical demultiplexer circuit are configured to demultiplex a wavelength component from the two or more polarized optical signals, as opposed to having separate optical resonator structures for each of the two or more polarized optical signals. The two or more polarized optical signals may propagate along an optical waveguide loop in opposite directions toward the optical resonator structure and may optically couple to the waveguide structure through the optical resonator structure. The length of the optical waveguide structure, and the positioning of the photodetector structure along the optical waveguide structure, are selected such that the two or more polarized optical signals travel approximately a same distance to the photodetector structure such that the two or more polarized optical signals are synchronized at the photodetector structure.

The optical demultiplexer circuit may include a similar arrangement of photonics components for demultiplexing the other wavelength components of the WDM optical signal. Since only a single optical resonator structure is included for each wavelength component for coupling the two or more polarized optical signals from the optical waveguide loop to an associated optical waveguide structure (e.g., as opposed to including an optical resonator structure for each of the two or more polarized optical signals), the scaling complexity for added data streams for the WDM optical signal is reduced to a 1:1 scale of added data stream to additional optical resonator structure. This enables additional data streams to be multiplexed onto the WDM optical signal for increased optical communication bandwidth and efficiency with minimal increase in the power consumption and complexity of the optical demultiplexer circuit.

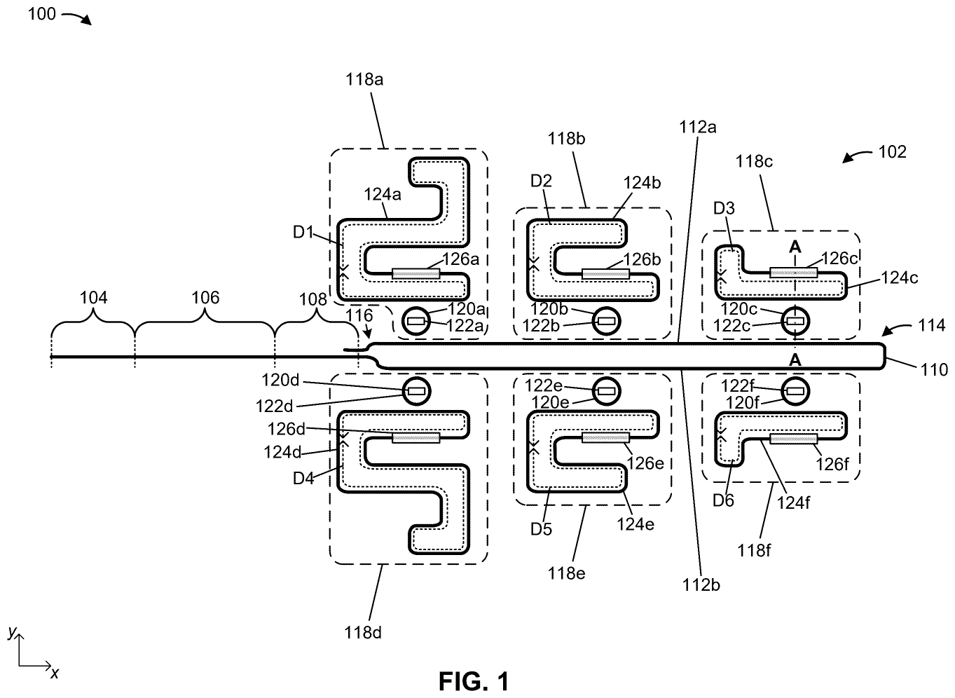

FIG. 1 is a diagram of an example semiconductor photonics device 100 described herein. The semiconductor photonics device 100 is a semiconductor device that includes at least one photonic integrated circuit. The photonic integrated circuit may include an optical demultiplexing circuit 102 that is configured to demultiplex WDM optical signals and/or other types of multiplexed optical signals.

As shown in FIG. 1, the optical demultiplexing circuit 102 may be optically coupled to one or more other photonics components of the semiconductor photonics device 100, such as an edge coupler waveguide structure 104, a coupling waveguide structure 106, and/or a polarization splitter and rotator (PSR) waveguide structure 108, among other examples. The edge coupler waveguide structure 104, the coupling waveguide structure 106, and the PSR waveguide structure 108 may be arranged in an x-direction in the semiconductor photonics device 100, and the coupling waveguide structure 106 may be located between the edge coupler waveguide structure 104 and the PSR waveguide structure 108 in the x-direction.

The edge coupler waveguide structure 104 may be configured to receive input optical signals (e.g., unpolarized optical signals) from an external optical input such as an optical fiber input. The input optical signals may propagate through the edge coupler waveguide structure 104 and to the coupling waveguide structure 106. The coupling waveguide structure 106 optically couples the input optical signals from the edge coupler waveguide structure 104 to the PSR waveguide structure 108. The PSR waveguide structure 108 is a type of optical splitter structure that splits the input optical signals into a plurality of polarized optical signals and provides the polarized optical signals to the optical demultiplexing circuit 102.

The optical demultiplexing circuit 102 is configured to demultiplex the wavelength components of input optical signals into separate data streams. The optical demultiplexing circuit 102 includes an optical waveguide loop 110 that includes elongated branches 112a and 112b that extend in the x-direction. The branches 112a and 112b of the optical waveguide loop 110 are coupled together at a loop end 114 of the optical waveguide loop 110 such that the optical waveguide loop 110 continuously extends around the loop end 114. The branches 112a and 112b of the optical waveguide loop 110 are spaced apart and are disconnected at an input end 116 of the optical waveguide loop 110 such that polarized optical signals may be provided to the branches 112a and 112b independently. The input end 116 may be referred to as a proximal end of the optical waveguide loop 110 in that the input end 116 is located closest to the PSR waveguide structure 108, and loop end 114 may be referred to as a distal end of the optical waveguide loop 110 in that the loop end 114 is located furthest away from the PSR waveguide structure 108.

As further shown in FIG. 1, the optical demultiplexing circuit 102 includes a plurality of wavelength component demultiplexing circuits, such as wavelength component demultiplexing circuits 118a-118f. Each of the wavelength component demultiplexing circuits 118a-118f is configured to demultiplex a particular wavelength component of one or more polarized optical signals received at the optical demultiplexing circuit 102. For example, six wavelength components may be multiplexed onto an input optical signal, and therefore the optical demultiplexing circuit 102 may include six wavelength component demultiplexing circuits 118a-118f, where each wavelength component demultiplexing circuit 118a-118f is configured to demultiplex one of the six wavelength components. Thus, the quantity of the wavelength component demultiplexing circuits 118a-118f illustrated in FIG. 1 is an example, and the quantity of wavelength component demultiplexing circuits 118a-118f included in the optical demultiplexing circuit 102 may be based on the quantity of wavelength components that are multiplexed onto the input optical signals processed by the optical demultiplexing circuit 102.

A first subset of the wavelength component demultiplexing circuits 118a-118f may be located adjacent to the branch 112a, and a second subset of the wavelength component demultiplexing circuits 118a-118f may be located adjacent to the branch 112b. For example, the wavelength component demultiplexing circuits 118a-118c may be located laterally adjacent to the branch 112a, and the wavelength component demultiplexing circuits 118d-118f may be located laterally adjacent to the branch 112b. In some implementations, the quantity of wavelength component demultiplexing circuits located adjacent to the branch 112a, and the quantity of wavelength component demultiplexing circuits located adjacent to the branch 112b, are the same quantity. In some implementations, the quantity of wavelength component demultiplexing circuits located adjacent to the branch 112a, and the quantity of wavelength component demultiplexing circuits located adjacent to the branch 112b, are different quantities.

The wavelength component demultiplexing circuits 118a-118c that are located laterally adjacent to the branch 112a may be laterally distributed along the branch 112a in the x-direction. The wavelength component demultiplexing circuit 118a may be located closer to the input end 116 of the optical waveguide loop 110 than the wavelength component demultiplexing circuits 118b and 118c. The wavelength component demultiplexing circuit 118c may be located closer to the loop end 114 of the optical waveguide loop 110 than the wavelength component demultiplexing circuits 118a and 118b. The wavelength component demultiplexing circuit 118b may be located laterally between the wavelength component demultiplexing circuits 118a and 118c in the x-direction.

The wavelength component demultiplexing circuits 118d-118f that are located laterally adjacent to the branch 112b may be laterally distributed along the branch 112b in the x-direction. The wavelength component demultiplexing circuit 118d may be located closer to the input end 116 of the optical waveguide loop 110 than the wavelength component demultiplexing circuits 118e and 118f. The wavelength component demultiplexing circuit 118f may be located closer to the loop end 114 of the optical waveguide loop 110 than the wavelength component demultiplexing circuits 118d and 118e. The wavelength component demultiplexing circuit 118e may be located laterally between the wavelength component demultiplexing circuits 118d and 118f in the x-direction.

Each of the wavelength component demultiplexing circuits 118d-118f includes a single optical resonator structure 120a-120f and an associated resonator heater structure 122a-122f. For example, the wavelength component demultiplexing circuit 118a includes a single optical resonator structure 120a and an associated resonator heater structure 122a, the wavelength component demultiplexing circuit 118b includes a single optical resonator structure 120b and an associated resonator heater structure 122b, and so on.

The optical resonator structure 120a includes a ring resonator (e.g., a micro-ring resonator (MRR) and/or another type of closed-loop optical resonator) that is configured to optically couple a particular wavelength component of polarized optical signals from the optical waveguide loop 110 to an associated closed-loop optical waveguide structure 124a. The resonator heater structure 122a includes a metal heater (e.g., a tungsten (W) heater and/or another type of metal heater), a semiconductor heater (e.g., a silicon (Si) heater and/or another type of semiconductor heater) that radiates heat toward the optical resonator structure 120a to stabilize the resonant frequency of the optical resonator structure 120a. The optical resonator structure 120a optically couples the wavelength component of the polarized optical signals that corresponds to the resonant frequency of the optical resonator structure 120a. The optical resonator structures 120b-120f and the resonator heater structures 122b-122f may be configured in a similar manner to optically couple other wavelength components of the polarized optical signals from the optical waveguide loop 110 and closed-loop optical waveguide structure 124b-124f, respectively.

The closed-loop optical waveguide structures 124a-124f may be “closed-loop” in that the closed-loop optical waveguide structures 124a-124f are each continuous waveguide structures that do not have a termination. The closed-loop optical waveguide structures 124a-124f may include semiconductor waveguide structures (e.g., silicon (Si) waveguide structures), dielectric waveguide structures (e.g., silicon nitride (SiₓN_{y}) waveguide structures), and/or hybrid semiconductor/dielectric waveguide structures.

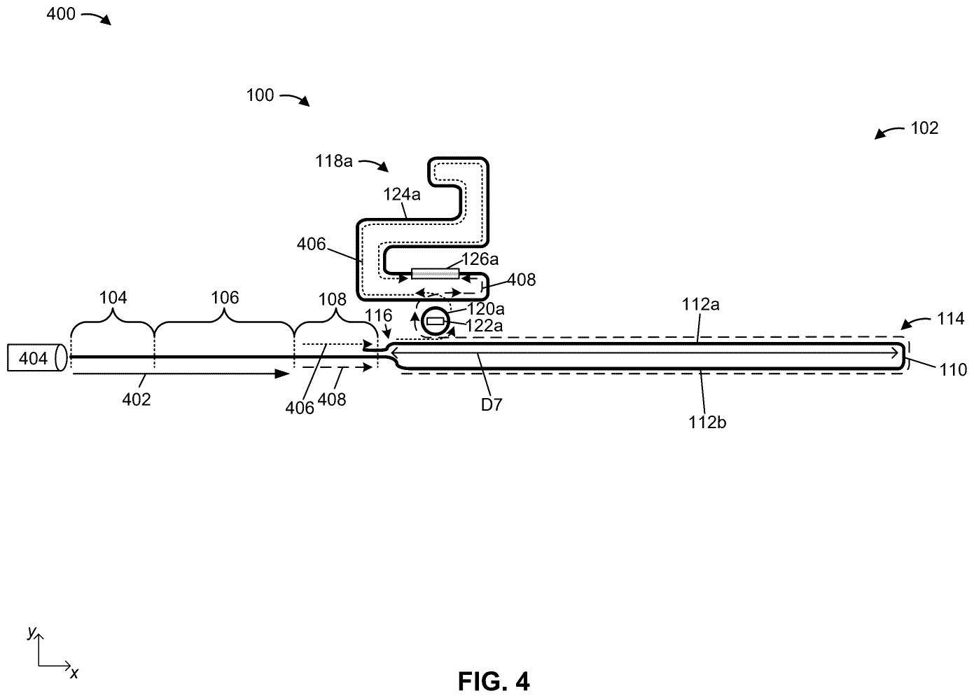

The polarized optical signals may propagate around the optical waveguide loop 110 in opposing directions such that the polarized optical signals are optically coupled to the optical resonator structure 120a in opposing directions. For example, a polarized optical signal received at the branch 112a at the input end 116 of the optical waveguide loop 110 may optically couple to the optical resonator structure 120a and may propagate around the optical resonator structure 120a in a counter-clockwise optical propagation path, and another polarized optical signal received at the branch 112b at the input end 116 of the optical waveguide loop 110 may propagate around the loop end 114 and through the branch 112a in an opposing direction to optically couple to the optical resonator structure 120a and propagate around the optical resonator structure 120a in a clockwise optical propagation path. This enables a single optical resonator structure 120a to be used to optically couple a plurality of polarized optical signals to the wavelength component demultiplexing circuits 118a, as opposed to including a separate optical resonator structure for each of the plurality of polarized optical signals. The optical resonator structures 120b-120f may optically couple a plurality of polarized optical signals to the wavelength component demultiplexing circuits 118b-118f, respectively, in a similar manner. A detailed example of the operation of the optical demultiplexing circuit 102 is illustrated and described in connection with FIG. 4.

The polarized optical signals optically coupled from the optical waveguide loop 110 to the closed-loop optical waveguide structure 124a may propagate around the closed-loop optical waveguide structure 124a to a photodetector structure 126a of the wavelength component demultiplexing circuit 118a included on the closed-loop optical waveguide structure 124a. The wavelength component demultiplexing circuits 118b-118f may include a similar arrangement of photodetector structures 126b-126f, respectively.

The photodetector structures 126a-126f may be configured to convert the wavelength components of the polarized optical signals (e.g., that were demultiplexed by the wavelength component demultiplexing circuits 118a-118f) to electrical signals corresponding to the data streams carried on those wavelength components. The photodetector structures 126a-126f may include a semiconductor photodetector structure (e.g., a germanium (Ge) photodetector and/or another type of semiconductor photodetector structure) that is configured to convert photons of received polarized optical signals to electrons of electrical signals.

Since the plurality of polarized optical signals that are optically coupled from the optical waveguide loop 110 to the closed-loop optical waveguide structure 124a through the optical resonator structure 120a propagate along different optical propagation paths, the different lengths of the different optical propagation paths might result in delayed reception of one of the polarized optical signals at the photodetector structure 126a. For example, a first polarized optical signal that is received at the branch 112a may propagate along a shorter optical propagation path to the optical resonator structure 120a than a second polarized optical signal that is received at the branch 112b and that propagates through the loop end 114 and back along the branch 112a to the optical resonator structure 120a. To compensate for the longer optical propagation path of the second polarized optical signal, the length of the closed-loop optical waveguide structure 124a, and the location of the photodetector structure 126a, may be selected to ensure that the first polarized optical signal propagates along a longer optical propagation path through the closed-loop optical waveguide structure 124a to the photodetector structure 126a than the second polarized optical signal. To achieve this, the photodetector structure 126a may be positioned along the closed-loop optical waveguide structure 124a such that opposing optical propagation paths through the closed-loop optical waveguide structure 124a to the photodetector structure 126a have different lengths. Thus, the closed-loop optical waveguide structure 124a is an optical delay line that introduces a propagation delay in the closed-loop optical waveguide structure 124a for the first optical signal to compensate for the propagation delay of the second optical in the optical waveguide loop 110. The length of the closed-loop optical waveguide structure 124a (indicated in FIG. 1 as dimension D1) may be selected such that the length of an overall optical propagation path from the input end 116 of the optical waveguide loop 110 to the photodetector structure 126a for the first polarized optical signal, and the length of overall optical propagation path from the input end 116 of the optical waveguide loop 110 to the photodetector structure 126a for the second polarized optical signal, are approximately equal, so that the first polarized optical signal and the second polarized optical signal are received at the photodetector structure 126a at approximately the same time. The lengths of the closed-loop optical waveguide structures 124b-124f (indicated in FIG. 1 as dimensions D2-D6, respectively) may be selected in a similar manner.

Because one of the polarized optical signals must propagate through the loop end 114 and along both branches 112a and 122b back toward the input end 116, the closer that a wavelength component demultiplexing circuit is located to the input end 116, the longer the closed-loop optical waveguide structure is. This is because the closer that a wavelength component demultiplexing circuit is located to the input end 116, the greater the difference in propagation delay through the optical waveguide loop 110 for the polarized optical signals. For example, a first polarized optical signal that is received at the branch 112a and that propagates through the loop end 114 and back along the branch 112b to the closed-loop optical waveguide structure 124d must travel a further distance than a second polarized optical signal that is received at the branch 112b and propagates to the closed-loop optical waveguide structure 124d. The delay between the first polarized optical signal and the second polarized optical signal is greater for the closed-loop optical waveguide structure 124d than for the closed-loop optical waveguide structure 124f because the first polarized optical signal propagates a lesser distance along the branch 112b to the closed-loop optical waveguide structure 124f, and the second polarized optical propagates a greater distance along the branch 112b to the closed-loop optical waveguide structure 124f. Thus, the length of the closed-loop optical waveguide structures 124a-124f increase the closer that the closed-loop optical waveguide structures 124a-124f are located to the input end 116 of the optical waveguide loop 110, and the length of the closed-loop optical waveguide structures 124a-124f decrease the closer that the closed-loop optical waveguide structures 124a-124f are located to the loop end 114 of the optical waveguide loop 110. Accordingly, the length of the closed-loop optical waveguide structure 124a (dimension D1) may be greater than the lengths of the closed-loop optical waveguide structures 124b (dimension D2), 124c (dimension D3), 124e (dimension D5), and 124f (dimension D6). The length of the closed-loop optical waveguide structure 124d (dimension D4) may also be greater than the lengths of the closed-loop optical waveguide structures 124b (dimension D2), 124c (dimension D3), 124e (dimension D5), and 124f (dimension D6). If the closed-loop optical waveguide structures 124a and 124d are located a similar distance from the input end 116 of the optical waveguide loop 110, the length of the closed-loop optical waveguide structure 124a (dimension D1) and the length of the closed-loop optical waveguide structure 124d (dimension D4) may be approximately the same length.

The length of the closed-loop optical waveguide structure 124c (dimension D3) may be less than the lengths of the closed-loop optical waveguide structures 124a (dimension D1), 124b (dimension D2), 124d (dimension D4), and 124e (dimension D5) because of the closed-loop optical waveguide structure 124c being located closer to the loop end 114 of the optical waveguide loop 110 than the closed-loop optical waveguide structures 124a, 124b, 124d, and 124e. Similarly, the length of the closed-loop optical waveguide structure 124f (dimension D6) may be less than the lengths of the closed-loop optical waveguide structures 124a (dimension D1), 124b (dimension D2), 124d (dimension D4), and 124e (dimension D5) because of the closed-loop optical waveguide structure 124c being located closer to the loop end 114 of the optical waveguide loop 110 than the closed-loop optical waveguide structures 124a, 124b, 124d, and 124e.

Alternatively, the closed-loop optical waveguide structure 124a and the closed-loop optical waveguide structure 124b may have the same length (e.g., dimension D1 and dimension D2 are approximately equal), and the photodetector structure 126a may be located along the closed-loop optical waveguide structure 124a such that the photodetector structure 126a is further away from being equidistant to the optical resonator structure 120a along opposing optical propagation paths through the closed-loop optical waveguide structure 124a than the photodetector structure 126b is from being equidistant to the optical resonator structure 120b along opposing optical propagation paths through the closed-loop optical waveguide structure 124b.

As indicated above, FIG. 1 is provided as an example. Other examples may differ from what is described with regard to FIG. 1.

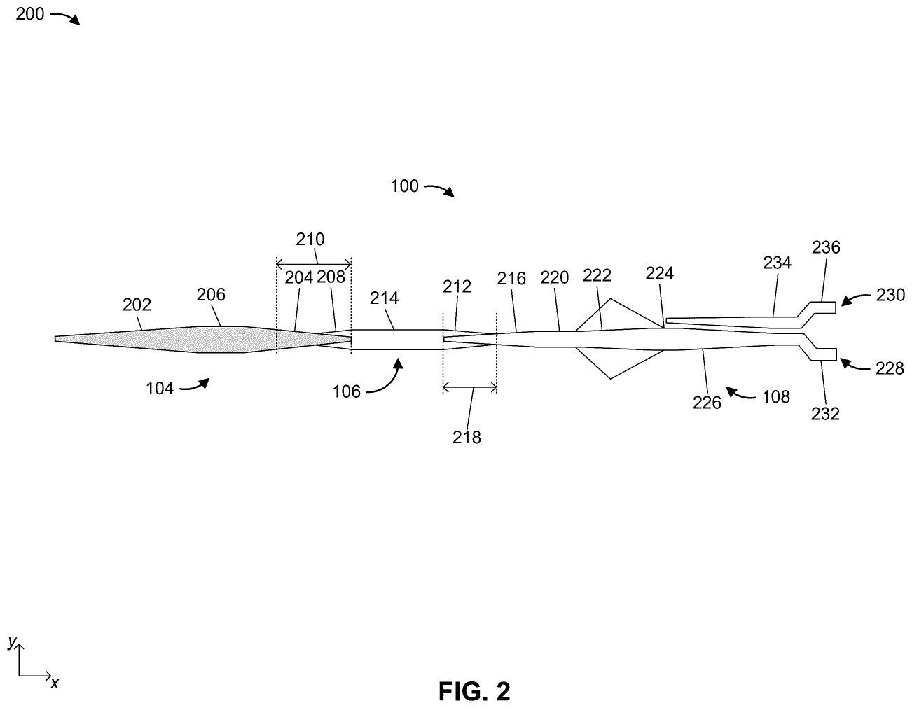

FIG. 2 is a diagram of an example 200 of a portion of the semiconductor photonics device 100 described herein. FIG. 2 illustrates a top view of the portion of the semiconductor photonics device 100, which includes the edge coupler waveguide structure 104, the coupling waveguide structure 106, and the PSR waveguide structure 108. As shown in FIG. 2, the edge coupler waveguide structure 104, the coupling waveguide structure 106, and the PSR waveguide structure 108 may each extend in the x-direction in the semiconductor photonics device 100.

The edge coupler waveguide structure 104 may include a tapered section 202, a tapered section 204, and a transition section 206 between the tapered sections 202 and 204. The tapered section 202 may be optically coupled with an optical fiber, a fiber optic cable, and/or another type of external optical input.

The edge coupler waveguide structure 104 may include a dielectric waveguide that includes one or more dielectric materials. Examples of dielectric materials that may be included in the edge coupler waveguide structure 104 include silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Alternatively, the edge coupler waveguide structure 104 may include a semiconductor material such as silicon (Si) among other examples.

The coupling waveguide structure 106 may include a tapered section 208 at a first end of the coupling waveguide structure 106. The tapered section 208 of the coupled waveguide structure 106 may at least partially overlap with the tapered section 204 of the edge coupler waveguide structure 104. The overlap may correspond to a coupling region 210 between the edge coupler waveguide structure 104 and the coupling waveguide structure 106. The coupling region 210 is where input optical signals transition between the edge coupler waveguide structure 104 and the coupling waveguide structure 106. The coupling waveguide structure 106 may include another tapered section 212 at a second end of the coupling waveguide structure 106 opposing the first end, and a transition section 214 between the tapered sections 208 and 212.

In some implementations, the coupling waveguide structure 106 includes a dielectric waveguide that includes one or more dielectric materials. In some implementations, the coupling waveguide structure 106 includes a semiconductor waveguide that includes one or more semiconductor materials. Examples of semiconductor materials include silicon (Si), germanium (Ge), and/or another semiconductor material.

The PSR waveguide structure 108 may include a tapered section 216 that at least partially overlaps with the tapered section 212 of the coupling waveguide structure 106 in a coupling region 218 between the coupling waveguide structure 106 and the PSR waveguide structure 108. The coupling region 218 is where input optical signals transition between the coupling waveguide structure 106 and the PSR waveguide structure 108. The PSR waveguide structure 108 may also include a transition section 220, a dual tapered section 224, and another transition section 226.

At an end of the PSR waveguide structure 108 opposing the tapered section 212, the PSR waveguide structure 108 may include a through segment 228 and a cross segment 230 that extends alongside the through segment 228 in the x-direction. The through segment 228 may include a tapered section 226 and an output section 232 optically coupled to the tapered section 226. The through segment 228 may include different types of sections and/or a different arrangement of sections. The cross segment 230 may include a tapered section 234 and an output section 236 optically coupled to the tapered section 234.

The PSR waveguide structure 108 may be configured to split an input optical signal into two orthogonal polarized optical signals: a transverse electric (TE) polarized optical signal and a transverse magnetic (TM) polarized optical signal. The PSR waveguide structure 108 then rotates one of the polarized optical signals such that two separated TE polarized optical signals (e.g., a TE polarized optical signal and a rotated TE polarized optical signal) or two separated TM polarized optical signals (e.g., a TM polarized optical signal and a rotated TM polarized optical signal) are provided as output from the PSR waveguide structure 108 at the output sections 232 and 236. For example, a TE polarized optical signal may be provided through the output section 232 of the through segment 228 to the branch 112b of the optical waveguide loop 110 of the optical demultiplexing circuit 102, and a rotated TE polarized optical signal may be provided through the output section 236 of the cross segment 230 to the branch 112a of the optical waveguide loop 110 of the optical demultiplexing circuit 102.

As indicated above, FIG. 2 is provided as an example. Other examples may differ from what is described with regard to FIG. 2.

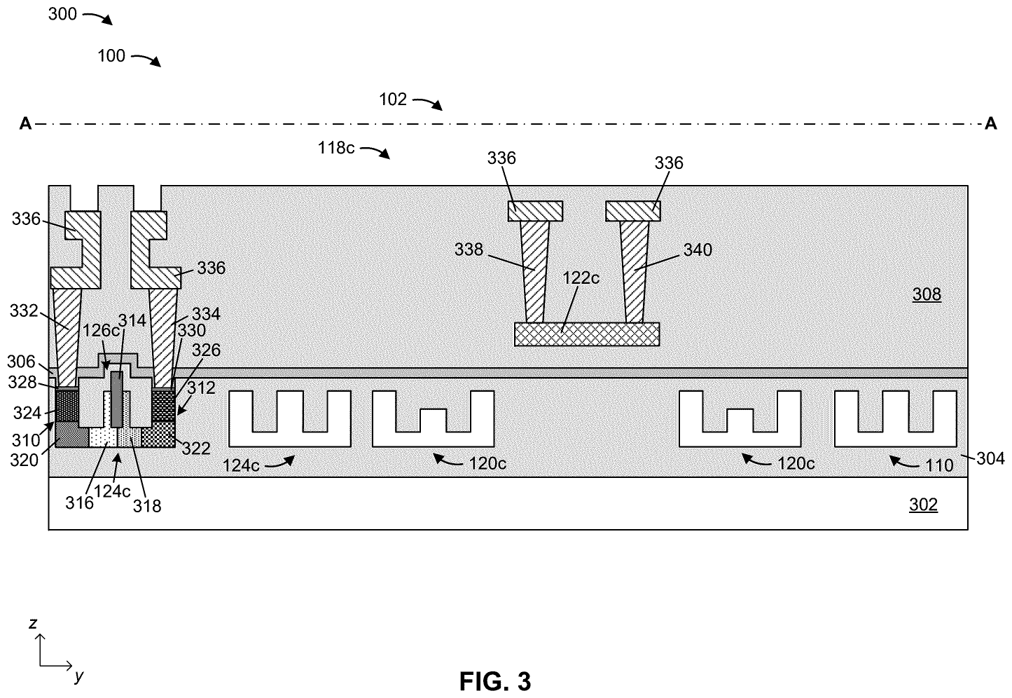

FIG. 3 is a diagram of an example implementation 300 of a cross-section view of a portion of the semiconductor photonics device 100 described herein. The example cross-section view illustrated in FIG. 3 is in the y-direction along the line A-A in FIG. 1, which is across portions of the wavelength component demultiplexing circuit 118c. It is to be noted that other wavelength component demultiplexing circuits, such as the wavelength component demultiplexing circuits 118a, 118b, 118d, 118e, and/or 118f may have a similar arrangement as shown in FIG. 3. Additionally and/or alternatively, other wavelength component demultiplexing circuits, such as the wavelength component demultiplexing circuits 118a, 118b, 118d, 118e, and/or 118f may have a different arrangement that what is shown in FIG. 3.

As shown in FIG. 3, the wavelength component demultiplexing circuit 118c is laterally adjacent to the optical waveguide loop 110 (e.g., the branch 112a of the optical waveguide loop 110) in the y-direction. In particular, a first side of the optical resonator structure 120c of the wavelength component demultiplexing circuit 118c is laterally adjacent to the optical waveguide loop 110. A second side of the optical resonator structure 120c is laterally adjacent to the closed-loop optical waveguide structure 124c (e.g., the optical delay line) of the wavelength component demultiplexing circuit 118c in the y-direction. Thus, the optical resonator structure 120c is located laterally between the optical waveguide loop 110 and the closed-loop optical waveguide structure 124a in the y-direction. The photodetector structure 126c is located on a portion of the closed-loop optical waveguide structure 124c. The resonator heater structure 122c may be located within a perimeter of the optical resonator structure 120c. Additionally and/or alternatively, the resonator heater structure 122c may be located outside the perimeter of the optical resonator structure 120c.

As further shown in FIG. 3, the wavelength component demultiplexing circuit 118c and the optical waveguide loop 110 may be located above a substrate layer 302 of the semiconductor photonics device 100. The substrate layer 302 may include a semiconductor material such as silicon (Si), silicon germanium (SiGe), and/or another suitable semiconductor material.

The optical waveguide loop 110, the optical resonator structure 120c, the closed-loop optical waveguide structure 124c, and/or the photodetector structure 126c may be included in a dielectric region 304 above the substrate layer 302. An etch stop layer 306 may be included above the dielectric region 304, and another dielectric region 308 may be included above the etch stop layer 306. In some implementations, the resonator heater structure 122c is located in the dielectric region 308, as shown in the example in FIG. 3. Additionally and/or alternatively, the resonator heater structure 122c may be located in the dielectric region 304 and/or in another layer of the semiconductor photonics device 100.

The dielectric region 304, the etch stop layer 306, and the dielectric region 308 may each include one or more dielectric materials. Examples of such dielectric materials include an oxide (e.g., a silicon oxide (SiOₓ) and/or another oxide material), an undoped silicate glass (USG), a boron-containing silicate glass (BSG), a fluorine-containing silicate glass (FSG), an extreme low dielectric constant (ELK) dielectric material having a dielectric constant that is less than approximately 2.5, a silicon nitride (SiₓN_{y}), silicon carbide (SiC), silicon oxynitride (SiON), and/or another suitable dielectric material.

In some implementations, the optical waveguide loop 110, the optical resonator structure 120c, the closed-loop optical waveguide structure 124c, and/or the photodetector structure 126c may be formed from the same semiconductor layer of the semiconductor photonics device 100. The optical waveguide loop 110, the optical resonator structure 120c, the closed-loop optical waveguide structure 124c, and/or the photodetector structure 126c may each include one or more semiconductor materials such as silicon (Si), doped silicon, germanium (Ge), silicon germanium (SiGe), a III-V semiconductor material, and/or another suitable semiconductor material. Additionally and/or alternatively, one or more of the optical waveguide loop 110, the optical resonator structure 120c, the closed-loop optical waveguide structure 124c, and/or the photodetector structure 126c may be formed from a dielectric layer and may include one or more dielectric materials described above and/or another suitable dielectric material.

The optical waveguide loop 110, the optical resonator structure 120c, the closed-loop optical waveguide structure 124c, and/or the photodetector structure 126c may each have a cross-sectional profile. The cross-sectional profiles of two or more of the optical waveguide loop 110, the optical resonator structure 120c, the closed-loop optical waveguide structure 124c, and/or the photodetector structure 126c may be approximately the same cross-sectional profile. For example, two or more of the optical waveguide loop 110, the optical resonator structure 120c, the closed-loop optical waveguide structure 124c, and/or the photodetector structure 126c may have a rib waveguide cross-sectional profile in which a ridge section is included above a slab section. As another example, two or more of the optical waveguide loop 110, the optical resonator structure 120c, the closed-loop optical waveguide structure 124c, and/or the photodetector structure 126c may have a strip waveguide cross-sectional profile. Additionally and/or alternatively, two or more of the optical waveguide loop 110, the optical resonator structure 120c, the closed-loop optical waveguide structure 124c, and/or the photodetector structure 126c may have different cross-sectional profiles.

The photodetector structure 126c may include a terminal section 310 and a terminal section 312 that facilitate electrical signals to be provided from the photodetector structure 126c. The photodetector structure 126c may generate the electrical signals based on optical signals received at an absorption region 314 of the photodetector structure 126c. The absorption region 314 may be included on the closed-loop optical waveguide structure 124c between the terminal sections 310 and 312. The absorption region 314 is configured to convert photons of received optical signals to electrons. The quantity of electrons generated may be based on the quantity of photons absorbed in the absorption region 314. Thus, the magnitude of the electrical signal (e.g., the magnitude of the electrical current of the electrical signal, the magnitude of the voltage of the electrical signal) generated by the photodetector structure 126c may be based on the intensity of optical signals received at the photodetector structure 126c. The electrons propagate through the closed-loop optical waveguide structure 124 to the terminal sections 310 and 312 that correspond to collection regions for the electrons generated by the absorption region 314.

The absorption region 314 may include an epitaxially grown region of semiconductor material that includes germanium (Ge), germanium tin (GeSn), silicon germanium (SiGe), indium gallium arsenide (InGaAs), and/or gallium arsenide (GaAs), among other examples. Photons of optical signals received at the photodetector structure 126c interact with electron-hole pairs in the semiconductor material of the absorption region 314. The interaction causes electrons and electron holes to be separated and to migrate toward opposing terminal sections 310, 312 (e.g., opposing collection regions), resulting in the generation of an electric field (e.g., a built-in electric field).

The portion of the waveguide loop 110 on which the photodetector structure 126c is located may be doped to promote the flow of electrons and/or electron holes between the absorption region 314 and the terminal sections 310, 312. For example, the absorption region 314 may be included on a doped region 316 and a doped region 318 of the waveguide loop 110. As another example, a doped region 320 may be included in the terminal section 310 and may be adjacent to the doped region 316, and a doped region 322 may be included in the terminal section 312 and may be adjacent to the doped region 318. As another example, a doped region 324 may be included above the doped region 320 in the terminal section 310, and a doped region 326 may be included above the doped region 322 in the terminal second 312.

The doped regions 316, 320, and 324 may include a semiconductor material that is doped with a first dopant type (e.g., an n-type dopant such as arsenic (As) and/or phosphorous (P), a p-type dopant such as boron (B) and/or gallium (Ga)), and the doped regions 318, 322, and 326 may include a semiconductor material that is doped with a second dopant type that is different from the first dopant type. For example, the doped regions 316, 320, and 324 may include n-type doped regions, and the doped regions 318, 322, and 326 may include p-type doped regions. The different dopant types facilitate the flow of electrons and electron holes from the absorption region 314 toward opposing terminal sections 310 and 312.

The doped region 320 may have a greater dopant concentration than the dopant concentration of the doped region 316, and the doped region 324 may have a greater dopant concentration than the dopant concentration of the doped region 320. The doped region 322 may have a greater dopant concentration than the dopant concentration of the doped region 318, and the doped region 326 may have a greater dopant concentration than the dopant concentration of the doped region 322.

Metal silicide layers 328 and 330 may be included on the terminal sections 310 and 312 of the photodetector structure 126c, respectively. The metal silicide layers 328 and 330 may each include a titanium silicide (TiSi), a ruthenium silicide (RuSi), and/or another type of metal silicide material. The metal silicide layers 328 and 330 provide a transition between the semiconductor material of the closed-loop optical waveguide structure 124c and contact structures 332 and 334 that are respectively formed on the terminal sections 310 and 312 of the photodetector structure 126c. The metal silicide layers 328 and 330 enable a low contact resistance to be achieved between the contact structures 332 and 334 and the terminal sections 310 and 312 of the photodetector structure 126c.

In some implementations, the contact structures 332 and 334 may each include one or more electrically conductive materials, such as tungsten (W), cobalt (Co), ruthenium (Ru), titanium (Ti), aluminum (Al), copper (Cu), and/or gold (Au), among other examples of conductive materials. The contact structures 332 and 334 may each include a via, a contact plug, a trench, and/or another type of conductive structure.

The contact structures 332 and 334 may be electrically coupled and/or physically coupled with one or more metallization layers 336 in the dielectric region 308. The metallization layers 336 correspond to circuitry that enables signals and/or power to be provided to and/or from the photodetector structure 126c and/or other devices in the semiconductor photonics device 100. The metallization layers 336 may each include one or more electrically conductive materials, such as tungsten (W), cobalt (Co), ruthenium (Ru), titanium (Ti), aluminum (Al), copper (Cu), and/or gold (Au), among other examples of conductive materials. The metallization layers 336 may each include vias, trenches, contact plugs, conductive pads, conductive pillars, and/or another type of metallization layers.

Contact structures 338 and 340 may also be included on the resonator heater structure 122c. The contact structures 338 and 340 enable electrical inputs to be provided to the resonator heater structure 122c so that the electrical inputs can be dissipated by the resonator heater structure 122c and converted to heat that is radiated toward the optical resonator structure 120c to stabilize the operating temperature of the optical resonator structure 120c.

As indicated above, FIG. 3 is provided as an example. Other examples may differ from what is described with regard to FIG. 3.

FIG. 4 is a diagram of an example implementation 400 of optical signal propagation in the semiconductor photonics device 100 described herein. As shown in FIG. 4, an input optical signal 402 (e.g., an unpolarized input optical signal) may be received at the edge coupler waveguide structure 104 from an optical input fiber 404. The input optical signal 402 is a WDM optical signal that has random polarization, including a TM component and a TE component. The input optical signal 402 may propagate from the edge coupler waveguide structure 104 to the PSR waveguide structure 108 through the coupling waveguide structure 106.

The PSR waveguide structure 108 splits the input optical signal 402 into a TE polarized optical signal and a TM polarized optical signal (e.g., at the dual tapered section 222 shown in FIG. 2). One of the TE polarized optical signal or the TM polarized optical signal propagates through the cross segment 230 and is rotated to form a rotated polarized optical signal 406, whereas the other of the TE polarized optical signal or the TM polarized optical signal propagates through the through segment 228 unmodified as a polarized optical signal.

In some implementations, the TM polarized optical signal propagates through the cross segment 230, where the TM polarized optical signal is rotated to form a rotated TE polarized optical signal that is coupled to the branch 112a of the optical waveguide loop 110 at the input end 116. In these implementations, the TE polarized optical signal propagates through the through segment 228 unmodified and is coupled to the branch 112b of the optical waveguide loop 110 at the input end 116.

In some implementations, the TE polarized optical signal propagates through the cross segment 230, where the TE polarized optical signal is rotated to form a rotated TM polarized optical signal that is coupled to the branch 112a of the optical waveguide loop 110 at the input end 116. The TM polarized optical signal propagates through the through segment 228 unmodified and is coupled to the branch 112b of the optical waveguide loop 110 at the input end 116.

The rotated polarized optical signal 406 propagates through the branch 112a in the x-direction toward the loop end 114 of the optical waveguide loop 110 until the rotated polarized optical signal 406 reaches the optical resonator structure 120a of the wavelength component demultiplexing circuit 118a. The optical resonator structure 120a is configured to resonate a particular wavelength component of the rotated polarized optical signal 406 to extract a data stream associated with the wavelength component of the rotated polarized optical signal 406. The wavelength component of the rotated polarized optical signal 406 propagates around the optical resonator structure 120a and couples to the closed-loop optical waveguide structure 124a. The wavelength component of the rotated polarized optical signal 406 propagates along the closed-loop optical waveguide structure 124a until reaching the photodetector structure 126a, where the wavelength component of the rotated polarized optical signal 406 is converted to an electrical signal.

The polarized optical signal 408 propagates through the branch 112b in the x-direction toward the loop end 114 of the optical waveguide loop 110, propagates through the loop end 114, and propagates through the branch 112a toward the input end 116 until the polarized optical signal 408 reaches the optical resonator structure 120a. The optical resonator structure 120a is configured to resonate a particular wavelength component of the polarized optical signal 408 (e.g., the same wavelength component as was extracted from the rotated polarized optical signal 406) to extract the data stream associated with the wavelength component of the polarized optical signal 408. The wavelength component of the polarized optical signal 408 propagates around the optical resonator structure 120a and couples to the closed-loop optical waveguide structure 124a. The wavelength component of the polarized optical signal 408 propagates along the closed-loop optical waveguide structure 124a until reaching the photodetector structure 126a, where the wavelength component of the polarized optical signal 408 is converted to an electrical signal.

In this way, the rotated polarized optical signal 406 and the polarized optical signal 408 propagate in opposing directions around the optical waveguide loop 110, in opposing directions around the optical resonator structure 120a, and in opposing directions around the closed-loop optical waveguide structure 124a. The polarized optical signal 408 propagates through the optical resonator structure 120a in a clockwise optical propagation path, and the rotated polarized optical signal 406 propagates through the optical resonator structure 120a in a counter-clockwise optical propagation path. This enables a single optical resonator structure 120a to be implemented for optically coupling both the rotated polarized optical signal 406 and the polarized optical signal 408 from the optical waveguide loop 110 to the closed-loop optical waveguide structure 124a (e.g., as opposed to having separate optical resonator structures for optically coupling each of the rotated polarized optical signal 406 and the polarized optical signal 408).

The length of the closed-loop optical waveguide structure 124a (e.g., dimension D1) and the location of the photodetector structure 126a along the closed-loop optical waveguide structure 124a, are configured such that the distance of propagation of the rotated polarized optical signal 406 (e.g., from the PSR waveguide structure 108 to the photodetector structure 126a) and the distance of propagation of the polarized optical signal 408 (e.g., from the PSR waveguide structure 108 to the photodetector structure 126a) are approximately the same distance. This ensures that the rotated polarized optical signal 406 and the polarized optical signal 408 are synchronized at the photodetector structure 126a.

Being “synchronized” at the photodetector structure 126a refers to an optical delay time difference between reception of the rotated polarized optical signal 406 and reception of the polarized optical signal 408 at the photodetector structure 126a being less than a threshold percentage of the optical signal pulse width of the input optical signal 402. For example, the rotated polarized optical signal 406 and the polarized optical signal 408 may be synchronized if the optical delay time difference between reception of the rotated polarized optical signal 406 and reception of the polarized optical signal 408 at the photodetector structure 126a is less than approximately 30% of the optical signal pulse width of the input optical signal 402. However, other values for the threshold are within the scope of the present disclosure.

The wavelength component demultiplexing circuits 118b-118f may be configured to demultiplex other wavelength components of the rotated polarized optical signal 406 and the polarized optical signal 408 in a similar manner. The diameter (indicated in FIG. 4 as dimension D7) of the optical waveguide loop 110 (which may correspond to the lengths of the branches 112a and 112b of the optical waveguide loop 110) may be sized to accommodate a particular quantity of wavelength component demultiplexing circuits so that a particular quantity of wavelength components can be demultiplexed. In some implementations, the diameter of the optical waveguide loop 110 is included a range of approximately 1000 microns to approximately 2000 microns. However, other values and ranges are within the scope of the present disclosure.

As indicated above, FIG. 4 is provided as an example. Other examples may differ from what is described with regard to FIG. 4.

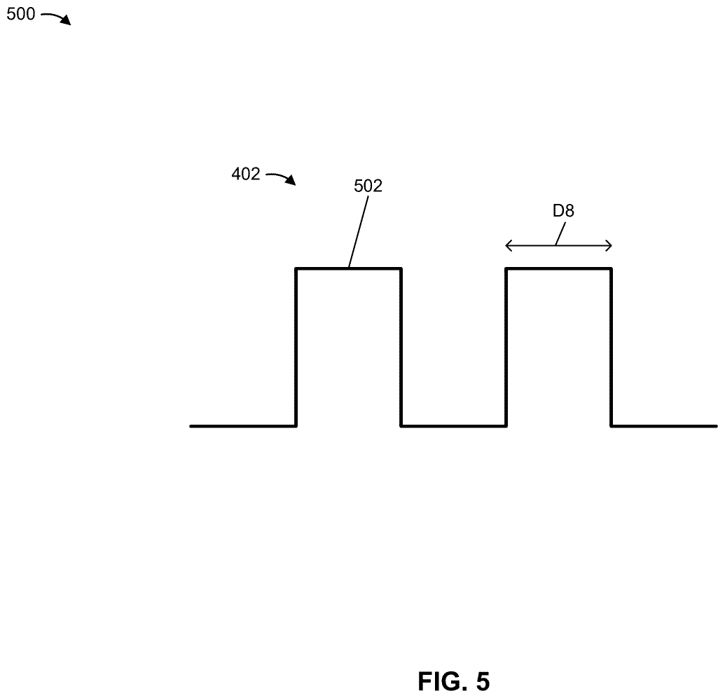

FIG. 5 is a diagram of an example 500 of an input optical signal 402 described herein. As indicated above, the rotated polarized optical signal 406 and the polarized optical signal 408 may be synchronized if the optical delay time difference between reception of the rotated polarized optical signal 406 and reception of the polarized optical signal 408 at the photodetector structure 126a is less than a threshold percentage of an optical signal pulse width (dimension D8) of an optical signal pulse 502 of the input optical signal 402. The optical signal pulse width (dimension D8) may be based on a data rate of the input optical signal 402. For example, if the data rate of the input optical signal 402 is approximately 50 gigabits per second (Gb/s), the optical signal pulse width (dimension D8) may be approximately 20 picoseconds. If the threshold percentage for synchronization is approximately 30%, the acceptable optical delay time difference between reception of the rotated polarized optical signal 406 and the polarized optical signal 408 may be approximately 6 picoseconds. In implementations in which the optical waveguide loop 110, the optical resonator structure 120a, and the closed-loop optical waveguide structure 124a are silicon (Si) waveguides, a 6-picosecond optical delay time may correspond to a maximum difference in distance between the distance of propagation of the rotated polarized optical signal 406 (e.g., from the PSR waveguide structure 108 to the photodetector structure 126a) and the distance of propagation of the polarized optical signal 408 (e.g., from the PSR waveguide structure 108 to the photodetector structure 126a) of approximately 600 microns. This, however, is an example, and other data rates, optical signal pulse widths, threshold percentages, and optical delay times are within the scope of the present disclosure.

As indicated above, FIG. 5 is provided as an example. Other examples may differ from what is described with regard to FIG. 5.

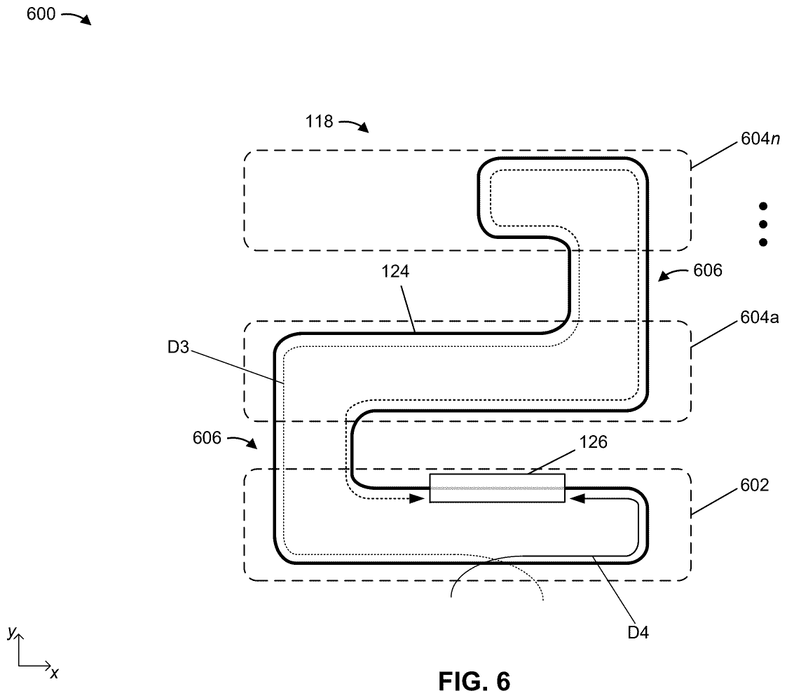

FIG. 6 is a diagram of an example implementation 600 of a portion of a wavelength component demultiplexing circuit 118 described herein. The wavelength component demultiplexing circuit 118 may correspond to one of the wavelength component demultiplexing circuits 118b-118f and/or another wavelength component demultiplexing circuit.

As shown in FIG. 6, the wavelength component demultiplexing circuit 118 includes a closed-loop optical waveguide structure 124 (e.g., a delay line) and a photodetector structure 126 optically coupled to the closed-loop optical waveguide structure 124. The photodetector structure 126 may be placed at a location along the closed-loop optical waveguide structure 124 such that the distance (dimension D3) along a first optical propagation path between the photodetector structure 126 and a location along the closed-loop optical waveguide structure 124 at which optical signals are coupled to the closed-loop optical waveguide structure 124, and the distance (dimension D4) along a second optical propagation path between the photodetector structure 126 and the location along the closed-loop optical waveguide structure 124 at which optical signals are coupled to the closed-loop optical waveguide structure 124, are unequal distances. The photodetector structure 126 may be positioned such that the distance (dimension D3) of the first optical propagation path is greater than the distance (dimension D4) of the second optical propagation path to compensate for the greater distance of signal propagation of optical signals along the optical waveguide loop 110 that are to propagate along the second optical propagation path of the closed-loop optical waveguide structure 124, and to compensate for the lesser distance of signal propagation of optical signals along the optical waveguide loop 110 that are to propagate along the first optical propagation path of the closed-loop optical waveguide structure 124.

The photodetector may be included in a main section 602 of the closed-loop optical waveguide structure 124. One or more extension sections 604a-604n may be optically coupled to the main section through transition sections 606. The length and/or quantity of the extension sections 604a-604n may be selected to achieve an overall length for the closed-loop optical waveguide structure 124 to achieve a particular amount of propagation delay and/or to facilitate optical coupling of a particular wavelength component to the wavelength component demultiplexing circuit 118. Thus, two or more wavelength component demultiplexing circuits 118 may include closed-loop optical waveguide structures 124 that have different quantities of extension sections 604a-604n and/or different lengths of the extension sections 604a-604n to achieve different amounts of propagation delay and/or to facilitate optical coupling of different wavelength components.

In the example illustrated in FIG. 6, the main section 602 and the extension sections 604a-604n form an overall serpentine top view shape, where the extension sections 604a-604n double back on each other. However, other arrangements of the main section 602 and the extension sections 604a-604n may include different top view shapes, including circular shapes, rounded shapes, zig-zag shapes, and/or non-standard shapes.

As indicated above, FIG. 6 is provided as an example. Other examples may differ from what is described with regard to FIG. 6.

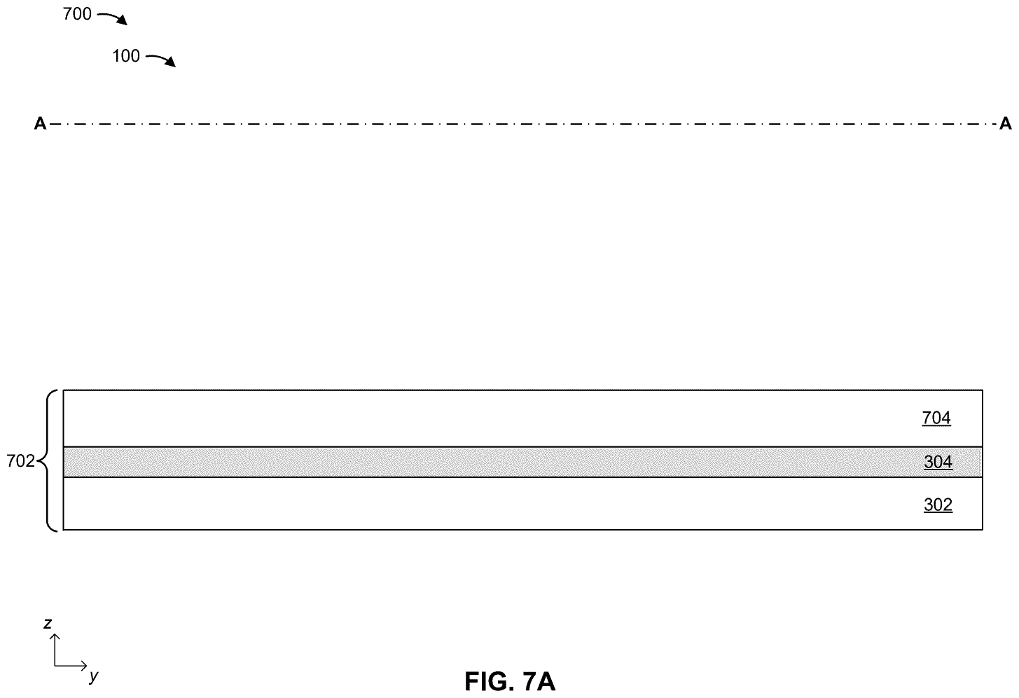

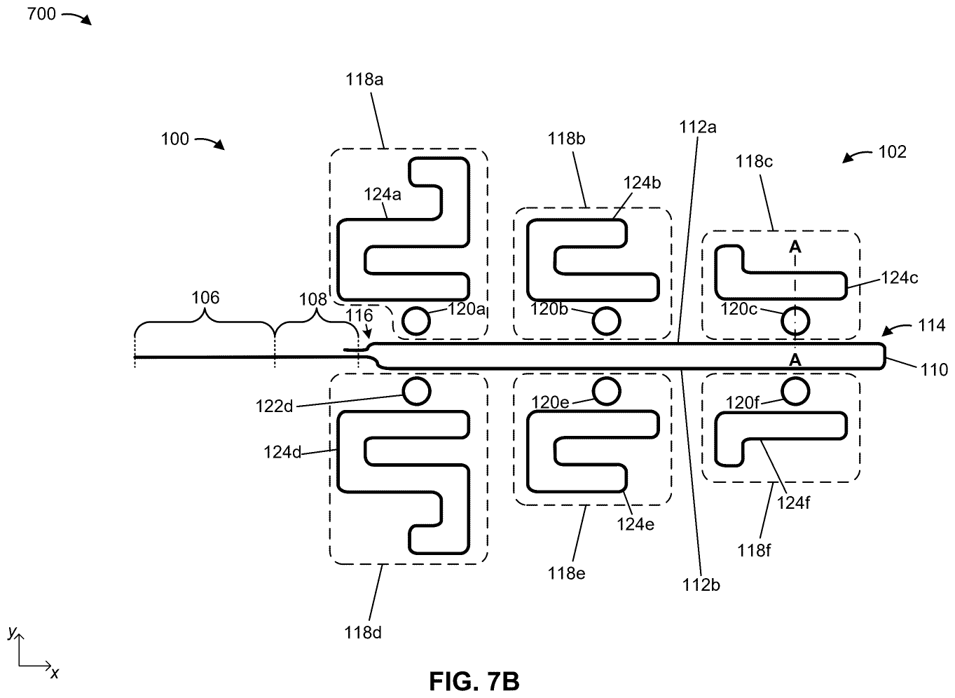

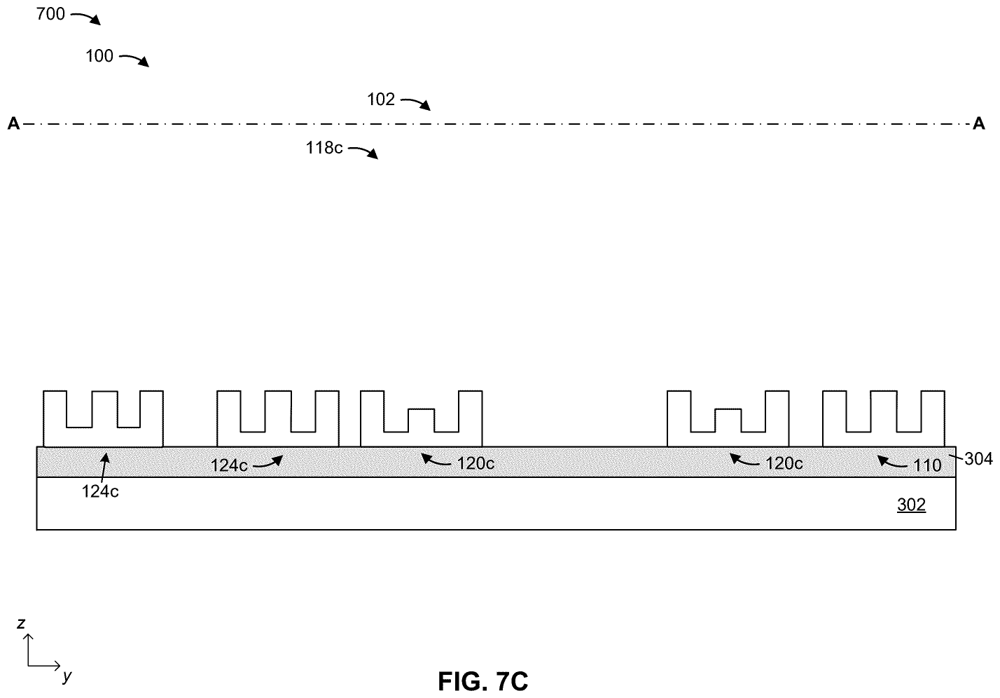

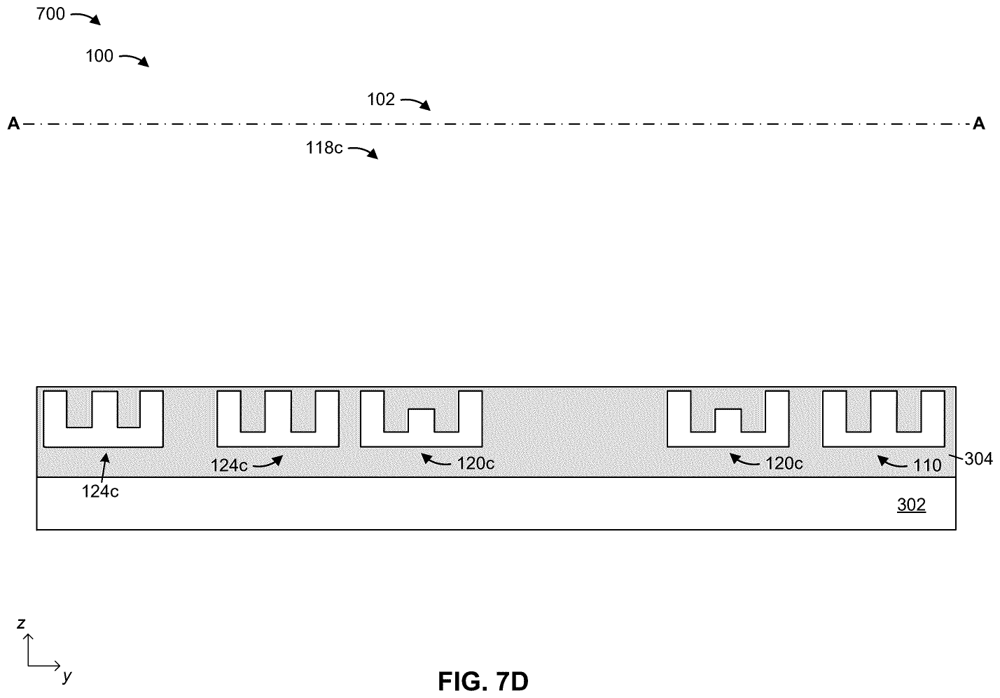

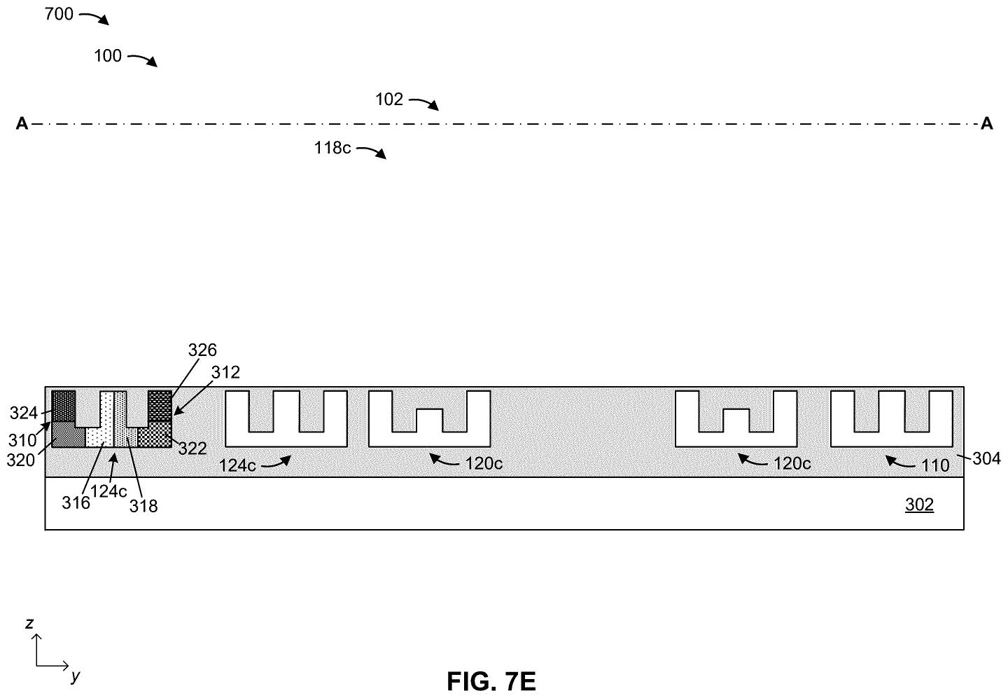

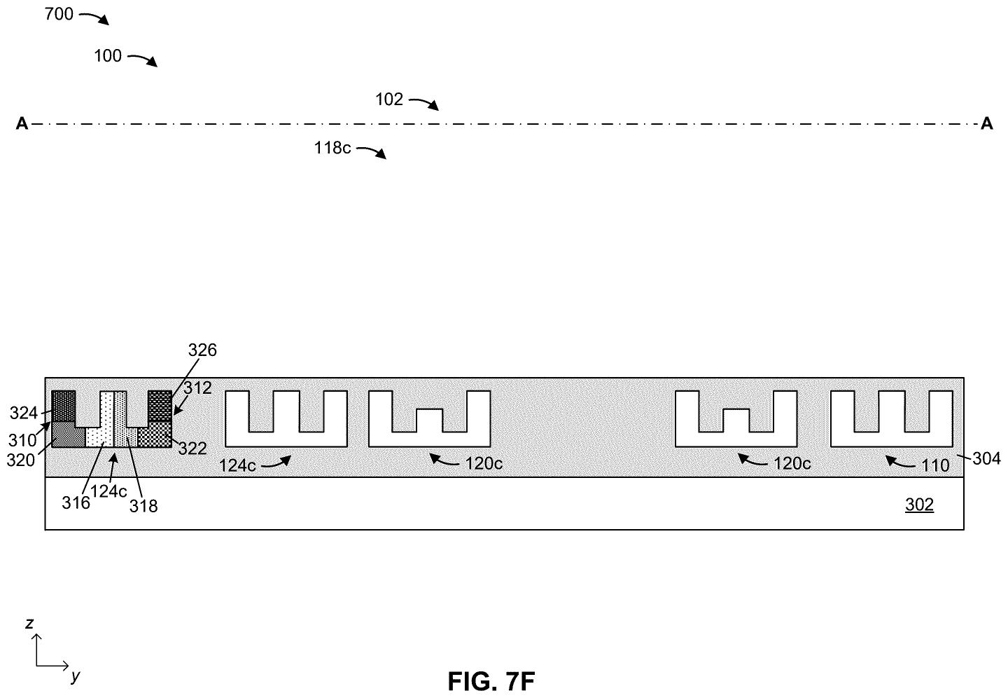

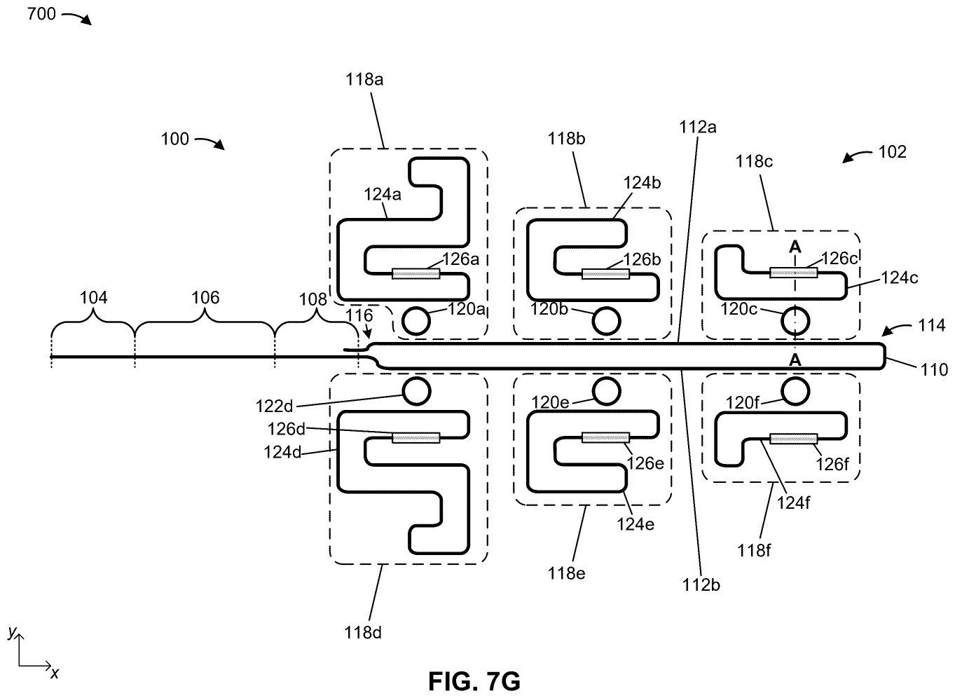

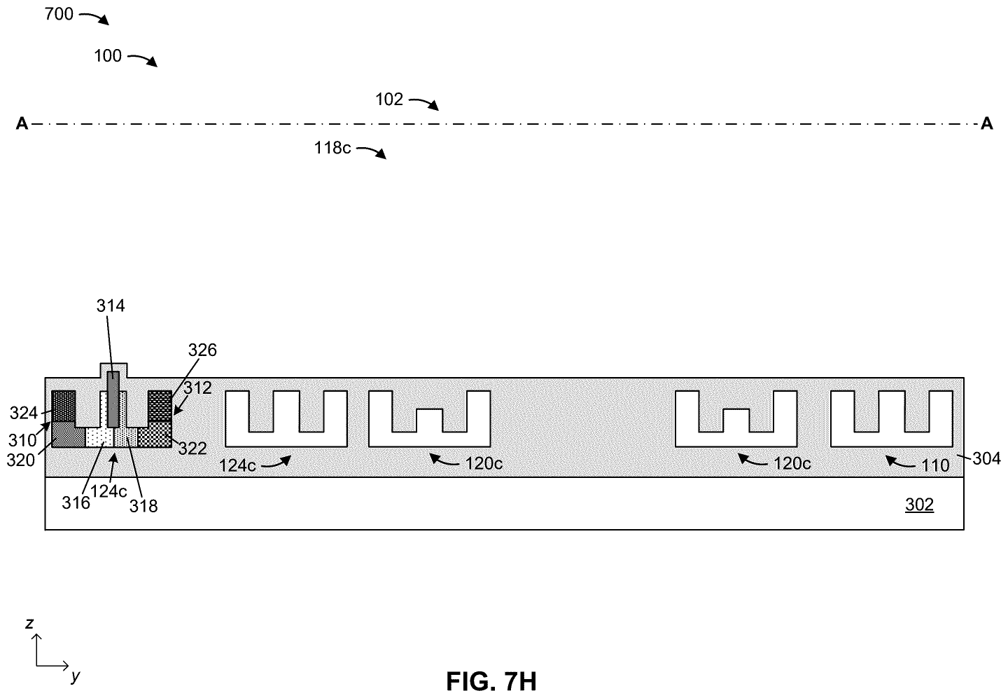

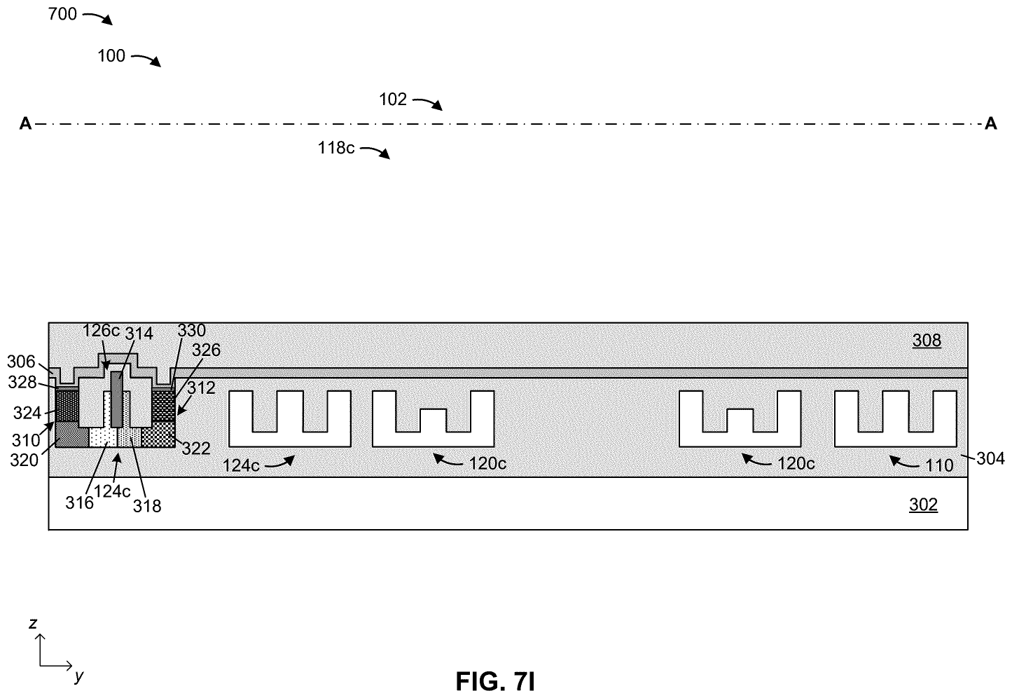

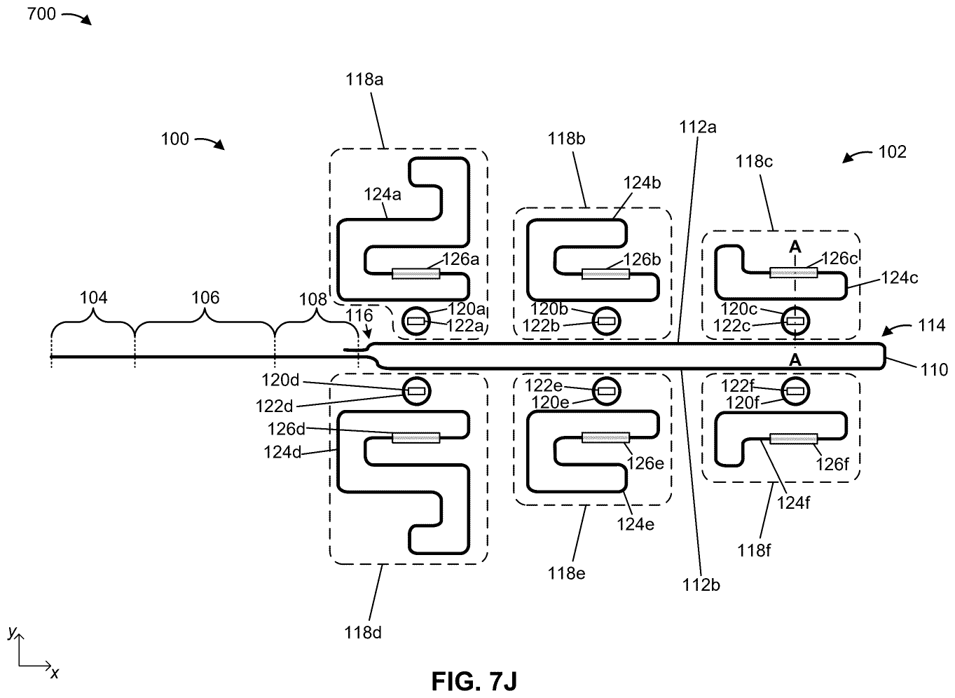

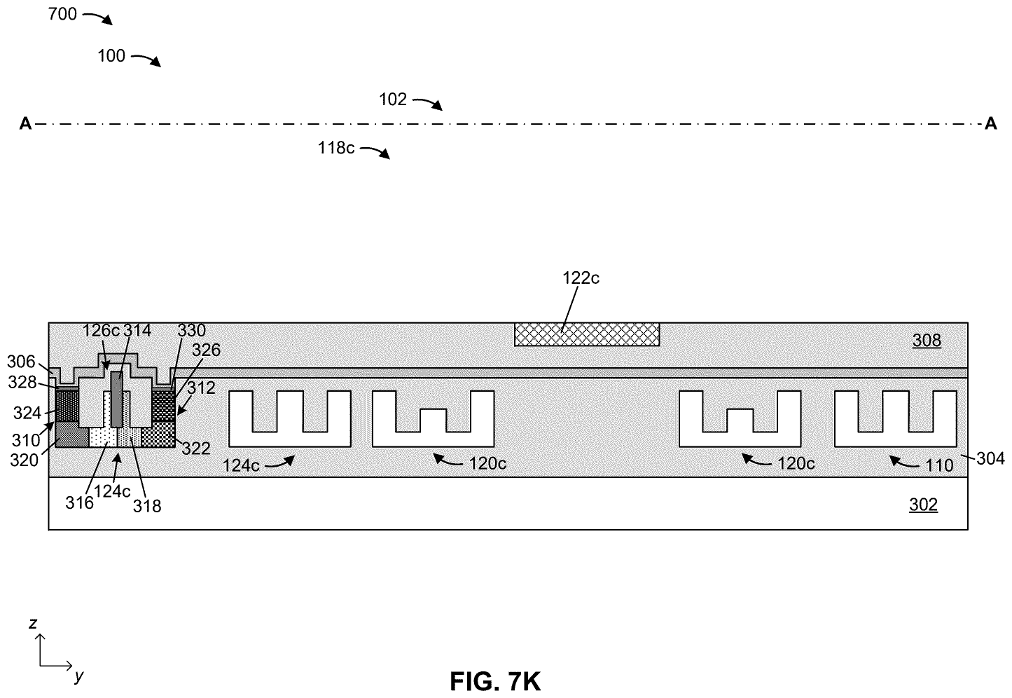

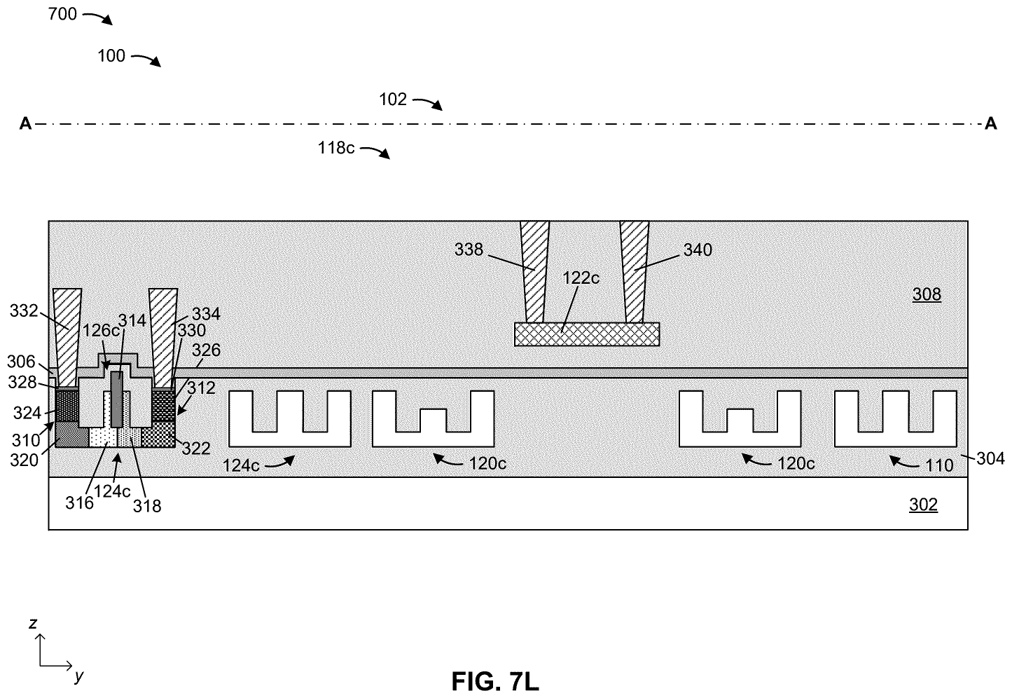

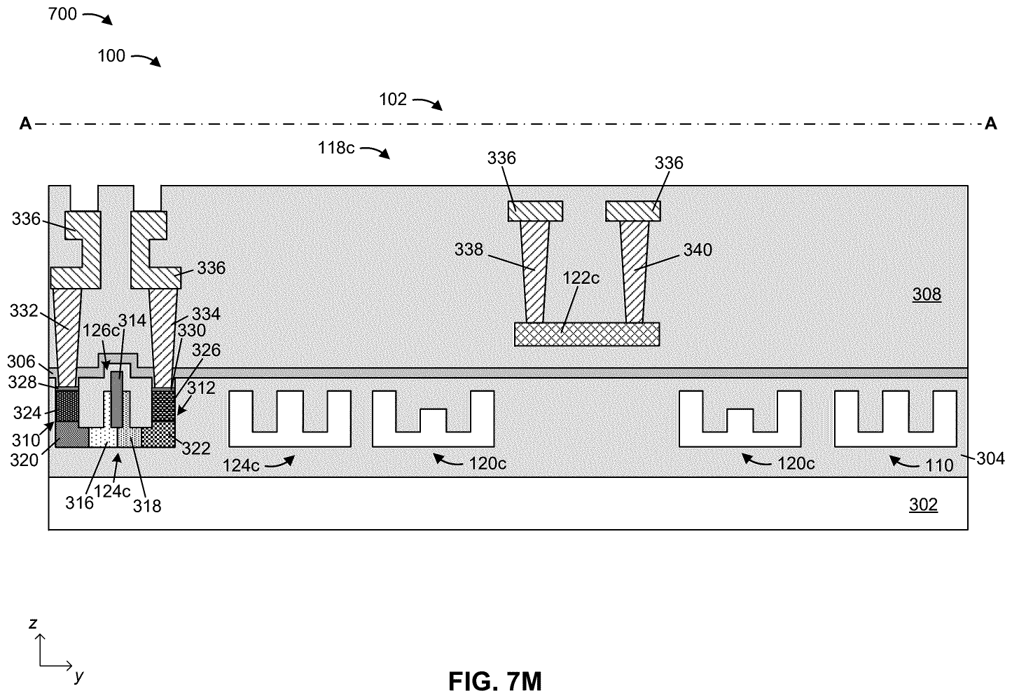

FIGS. 7A-7M are diagrams of an example implementation 700 of forming the semiconductor photonics device 100 (or a portion thereof) described herein. In some implementations, one or more of the operations described in connection with FIGS. 7A-7M may be performed using one or more semiconductor processing tools, such as a deposition tool, an exposure tool, a developer tool, an etch tool, a planarization tool, an ion implantation tool, an annealing tool, and/or a wafer/die transport tool, among other examples.

Turning to FIG. 7A, a substrate 702 may be provided. The substrate 702 may include a silicon on insulator (SOI) substrate that includes the substrate layer 302 (e.g., a silicon (Si) substrate and/or another type of semiconductor substrate), a portion of the dielectric region 304 (e.g., a buried oxide or bottom oxide (BOX) layer and/or another type of insulator layer) over and/or on the substrate layer 302, and a semiconductor layer 704 (e.g., a silicon (Si) layer and/or another type of semiconductor layer) over and/or on the portion of the dielectric region 304. Alternatively, the substrate layer 302 may be provided as a semiconductor wafer, and a deposition tool may be used to form the portion of the dielectric region 304 over and/or on the substrate layer 302, and may form the semiconductor layer 704 over and/or on the portion of the dielectric region 304. A deposition tool may be used to deposit the portion of the dielectric region 304 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 704 using an epitaxy technique and/or another type of deposition technique.

As shown in FIGS. 7B and 7C, one or more photonics components of the semiconductor photonics device 100 may be formed from the semiconductor layer 704. For example, the coupling waveguide structure 106 and/or the PSR waveguide structure 108 may be formed from the semiconductor layer 704. As another example, the optical waveguide loop 110 of the optical demultiplexing circuit 102 may be formed from the semiconductor layer 704. As another example, the optical resonator structures 120a-120f and/or the closed-loop optical waveguide structures 124a-124f of the wavelength component demultiplexing circuits 118a-118f of the optical demultiplexing circuit 102 may be formed from the semiconductor layer 704.

A single optical resonator structure and a single closed-loop optical waveguide structure may be formed for each of the wavelength component demultiplexing circuits. For example, the optical resonator structure 120a and the closed-loop optical waveguide structure 124a may be formed for the wavelength component demultiplexing circuit 118a, the optical resonator structure 120b and the closed-loop optical waveguide structure 124b may be formed for the wavelength component demultiplexing circuit 118b, and so on.

As shown in FIG. 7B, the optical waveguide loop 110 may be formed to include an open input end 116 and a closed loop end 114, where the input end 116 and the loop end 114 are located at opposing ends of the branches 112a and 112b of the optical waveguide loop 110. The optical waveguide loop 110 may be formed such that the input end 116 (e.g., the open end) of the optical waveguide loop 110 is optically coupled to the PSR waveguide structure 108.

The optical resonator structures 120a-120f may each be formed adjacent to a side of the optical waveguide loop 110. For example, the optical resonator structures 120a-120c may be formed adjacent to a first side (e.g., adjacent to the branch 112a) of the optical waveguide loop 110, and the optical resonator structures 120d-120f may be formed adjacent to a second side (e.g., adjacent to the branch 112b) of the optical waveguide loop 110 opposing the first side.

The closed-loop optical waveguide structures 124a-124f may be formed adjacent to the optical resonator structures 120d-120f, respectively. Thus, the optical resonator structures 120d-120f may be formed between the optical waveguide loop 110 and the closed-loop optical waveguide structures 124a-124f, respectively. Moreover, the closed-loop optical waveguide structures 124a-124c may be formed on the first side (e.g., adjacent to the branch 112a) of the optical waveguide loop 110, and the closed-loop optical waveguide structures 124d-124f may be formed on the second side (e.g., adjacent to the branch 112b) of the optical waveguide loop 110 opposing the first side.

The closed-loop optical waveguide structures 124a and 124d may be formed closest to the input end 116 of the optical waveguide loop 110. The closed-loop optical waveguide structures 124c and 124f may be formed closest to the loop end 114 of the optical waveguide loop 110. The closed-loop optical waveguide structure 124b may be formed laterally between the closed-loop optical waveguide structures 124a and 124c in the x-direction. The closed-loop optical waveguide structure 124e may be formed laterally between the closed-loop optical waveguide structures 124d and 124f in the x-direction.

The closed-loop optical waveguide structure 124a may be formed to have a length (dimension D1) that is greater than the lengths (dimension D2, dimension D3) of the closed-loop optical waveguide structures 124b and 124c. The closed-loop optical waveguide structure 124b may be formed to have a length (dimension D2) that is greater than the length (dimension D3) of the closed-loop optical waveguide structure 124c, and is less than the length (dimension D1) of the closed-loop optical waveguide structure 124a. The closed-loop optical waveguide structure 124c may be formed to have a length (dimension D3) that is less than the lengths (dimension D1, dimension D2) of the closed-loop optical waveguide structures 124a and 124b.

The closed-loop optical waveguide structure 124d may be formed to have a length (dimension D4) that is greater than the lengths (dimension D5, dimension D6) of the closed-loop optical waveguide structures 124e and 124f. The closed-loop optical waveguide structure 124e may be formed to have a length (dimension D5) that is greater than the length (dimension D6) of the closed-loop optical waveguide structure 124f, and is less than the length (dimension D4) of the closed-loop optical waveguide structure 124d. The closed-loop optical waveguide structure 124f may be formed to have a length (dimension D6) that is less than the lengths (dimension D4, dimension D5) of the closed-loop optical waveguide structures 124d and 124e.

The closed-loop optical waveguide structure 124a may be formed to have a length (dimension D1) that is greater than the lengths (dimension D5, dimension D6) of the closed-loop optical waveguide structures 124e and 124f. The closed-loop optical waveguide structure 124e may be formed to have a length (dimension D5) that is greater than the length (dimension D3) of the closed-loop optical waveguide structure 124c, and is less than the length (dimension D1) of the closed-loop optical waveguide structure 124a. The closed-loop optical waveguide structure 124e may be formed to have a length (dimension D6) that is less than the lengths (dimension D1, dimension D2) of the closed-loop optical waveguide structures 124a and 124b.

The closed-loop optical waveguide structure 124d may be formed to have a length (dimension D4) that is greater than the lengths (dimension D2, dimension D3) of the closed-loop optical waveguide structures 124b and 124c. The closed-loop optical waveguide structure 124b may be formed to have a length (dimension D2) that is greater than the length (dimension D6) of the closed-loop optical waveguide structure 124f, and is less than the length (dimension D4) of the closed-loop optical waveguide structure 124d. The closed-loop optical waveguide structure 124c may be formed to have a length (dimension D3) that is less than the lengths (dimension D4, dimension D5) of the closed-loop optical waveguide structures 124d and 124e.

As shown in FIG. 7C, the coupling waveguide structure 106, the PSR waveguide structure 108, the optical waveguide loop 110, the optical resonator structures 120a-120f, and/or the closed-loop optical waveguide structures 124a-124f may be formed from the same semiconductor layer 704 of the semiconductor photonics device 100. The semiconductor layer 704 may be etched based on one or more patterned masking layers to form the coupling waveguide structure 106, the PSR waveguide structure 108, the optical waveguide loop 110, the optical resonator structures 120a-120f, and/or the closed-loop optical waveguide structures 124a-124f.

In some implementations, a plurality of patterning and etching operations are performed to form the coupling waveguide structure 106, the PSR waveguide structure 108, the optical waveguide loop 110, the optical resonator structures 120a-120f, and/or the closed-loop optical waveguide structures 124a-124f from the semiconductor layer 704. For example, a first masking layer may be patterned in a first patterning operation and used to etch the semiconductor layer 704 in a first etch operation, a second masking layer may be patterned in a second patterning operation and used to etch the semiconductor layer 704 in a second etch operation, a third masking layer may be patterned in a third patterning operation and used to etch the semiconductor layer 704 in a third etch operation, and so on. The etch operation(s) may include a dry etch operation (e.g., a plasma-based etch operation, a gas-based etch operation), a wet chemical etch operation, and/or another type of etch operation.

Additionally and/or alternatively, one or more of the coupling waveguide structure 106, the PSR waveguide structure 108, the optical waveguide loop 110, the optical resonator structures 120a-120f, and/or the closed-loop optical waveguide structures 124a-124f may be formed from a dielectric layer that is deposited, patterned, and etched.

As shown in FIG. 7D, additional material of the dielectric region 304 may be deposited around the coupling waveguide structure 106, the PSR waveguide structure 108, the optical waveguide loop 110, the optical resonator structures 120a-120f, and/or the closed-loop optical waveguide structures 124a-124f. The additional material may be referred to as a shallow trench isolation (STI) portion of the dielectric region 304. A deposition tool may be used to deposit the additional material of the dielectric region 304 using a PVD technique, an atomic layer deposition (ALD) technique, a CVD technique, an oxidation technique, and/or another suitable deposition technique. In some implementations, a planarization tool may be used to perform a planarization operation (e.g., a chemical-mechanical planarization (CMP) operation) to planarize the dielectric region 304 after the additional material of the dielectric region 304 is deposited.

As shown in FIG. 7E, various portions of the closed-loop optical waveguide structures 124a-124f may be doped as part of forming the photodetector structures 126a-126f on the closed-loop optical waveguide structures 124a-124f, respectively. For example, the closed-loop optical waveguide structures 124a-124f may be doped with a first dopant type to form the doped regions 316, 320, and/or 324. As another example, the closed-loop optical waveguide structures 124a-124f may be doped with a second dopant type to form the doped regions 318, 322, and/or 326. The first dopant type and the second dopant type may be different dopant types. For example, the doped regions 316, 320, and 324 may be doped with n-type dopants, and the doped regions 318, 322, and 326 may be doped with p-type dopants. As another example, the doped regions 316, 320, and 324 may be doped with p-type dopants, and the doped regions 318, 322, and 326 may be doped with n-type dopants.

In some implementations, an ion implantation tool is used to implant ions into the portions of the closed-loop optical waveguide structures 124a-124f to form the doped regions 316-326. In these implementations, dopant ions (e.g., n-type ions, p-type ions) may be accelerated toward the portions of the closed-loop optical waveguide structures 124a-124f and implanted into the portions of the closed-loop optical waveguide structures 124a-124f to form the doped regions 316-326. In some implementations, the doped regions 316-326 are formed using another dopant technique such as diffusion.

As shown in FIG. 7F, additional material of the dielectric region 304 may be deposited above the coupling waveguide structure 106, the PSR waveguide structure 108, the optical waveguide loop 110, the optical resonator structures 120a-120f, and/or the closed-loop optical waveguide structures 124a-124f. A deposition tool may be used to deposit the additional material of the dielectric region 304 using a PVD technique, an ALD technique, a CVD technique, an oxidation technique, and/or another suitable deposition technique. In some implementations, a planarization tool may be used to perform a planarization operation (e.g., a CMP operation) to planarize the dielectric region 304 after the additional material of the dielectric region 304 is deposited.

As shown in FIGS. 7G and 7H, absorption regions 314 of the photodetector structures 126a-126f may be formed on the closed-loop optical waveguide structures 124a-124f. Forming the absorption regions 314 may include forming recesses in the closed-loop optical waveguide structures 124a-124f and forming the absorption region 314 in the recesses. The recesses may be formed into portions of the doped regions 316 and 318.

In some implementations, a pattern in a photoresist layer is used to etch the closed-loop optical waveguide structures 124a-124f to form the recesses. In these implementations, a deposition tool may be used to form the photoresist layer on the semiconductor photonics device 100 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the closed-loop optical waveguide structures 124a-124f based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recess based on a pattern.

The recesses may be filled with an epitaxially-grown semiconductor material to form the absorption region 314 of the photodetector structures 126a-126f. The epitaxially-grown semiconductor material may be a different material than the semiconductor material of the closed-loop optical waveguide structures 124a-124f. For example, the epitaxially-grown semiconductor material may include germanium (Ge), whereas the semiconductor material of the closed-loop optical waveguide structures 124a-124f may include doped silicon (Si). A deposition tool may be used to epitaxially grow the semiconductor material of the absorption regions 314 using an epitaxy technique. Additionally and/or alternatively, the absorption regions 314 may be deposited using an ALD technique, a CVD technique, and/or another suitable deposition technique.

Additional material of the dielectric region 304 may be formed over the semiconductor photonics device 100, including over the absorption regions 314 of the photodetector structures 126a-126f. A deposition tool may be used to deposit the additional material of the dielectric region 304 using a PVD technique, an ALD technique, a CVD technique, an oxidation technique, and/or another suitable deposition technique.

As shown in FIG. 7I, the dielectric region 304 may be etched to expose the tops of the terminal sections 310 and 312 of the photodetector structures 126a-126f, and the metal silicide layers 328 and 330 may be respectively formed on the terminal sections 310 and 312. Forming the metal silicide layers 328 and 330 may include depositing a layer of metal material (e.g., titanium (Ti), cobalt (Co), ruthenium (Ru), and/or nickel (Ni), among other examples) on the terminal sections 310 and 312 of the photodetector structures 126a-126f. A deposition tool may be used to deposit the metal material using a PVD technique, an ALD technique, a CVD technique, an electroplating technique, and/or another suitable deposition technique. An annealing tool may be used to perform an annealing operation to cause the metal material to diffuse into the terminal sections 310 and 312 of the photodetector structures 126a-126f to form the metal silicide layers 328 and 330.

As further shown in FIG. 7I, the etch stop layer 306 may be formed on the dielectric region 304 and on the metal silicide layers 328 and 330. A deposition tool may be used to deposit the etch stop layer 306 using a PVD technique, an ALD technique, a CVD technique, and/or another suitable deposition technique.

As further shown in FIG. 7I, a portion of the dielectric region 308 may be formed above the etch stop layer 306. A deposition tool may be used to deposit the portion of the dielectric region 308 using a PVD technique, an ALD technique, a CVD technique, and/or another suitable deposition technique. The portion of the dielectric region 308 may be formed in one or more deposition operations. In some implementations, a planarization tool is used to perform a planarization operation (e.g., a CMP operation) to planarize the portion of the dielectric region 308 after the portion of the dielectric region 308 is deposited.

As shown in FIG. 7J, the resonator heater structures 122a-122f of the wavelength component demultiplexing circuits 118a-118f may be formed. In some implementations, the resonator heater structures 122a-122f are formed within the perimeters of the optical resonator structures 120a-120f, respectively. Additionally and/or alternatively, one or more of the resonator heater structures 122a-122f may be formed outside the perimeters of the optical resonator structures 120a-120f.

As shown in FIG. 7K, the resonator heater structures 122a-122f may be formed in the dielectric region 308. Additionally and/or alternatively, one or more of the resonator heater structures 122a-122f may be formed in the dielectric region 304. To form the resonator heater structures 122a-122f, recesses may be formed in the dielectric region 308, and the resonator heater structures 122a-122f may be deposited in the recesses.

In some implementations, a pattern in a photoresist layer is used to etch the dielectric region 308 to form the recesses. In these implementations, a deposition tool may be used to form the photoresist layer on the dielectric region 308 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 308 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recess based on a pattern.

A deposition tool may be used to deposit the resonator heater structures 122a-122f in the recesses using a CVD technique, a PVD technique, an ALD technique, an electroplating technique, and/or another suitable deposition technique. The resonator heater structures 122a-122f may be deposited in one or more deposition operations. In some implementations, a seed layer is first deposited, and the resonator heater structures 122a-122f are deposited on the seed layer. In some implementations, a planarization tool is used to perform a planarization operation (e.g., a CMP operation) to planarize the resonator heater structures 122a-122f after the resonator heater structures 122a-122f are deposited.

As shown in FIG. 7L, additional material of the dielectric region 308 may be formed above the resonator heater structures 122a-122f. A deposition tool may be used to deposit the additional material of the dielectric region 308 using a PVD technique, an ALD technique, a CVD technique, and/or another suitable deposition technique. The additional material of the dielectric region 308 may be formed in one or more deposition operations. In some implementations, a planarization tool is used to perform a planarization operation (e.g., a CMP operation) to planarize the portion of the dielectric region 308 after the portion of the additional material of the dielectric region 308 is deposited.

As further shown in FIG. 7L, contact structures 332, 334, 338, and/or 340 may be formed in and/or through the dielectric region 308, the etch stop layer 306, and/or the dielectric region 304. The contact structures 332 and 334 may extend through the dielectric region 308, the etch stop layer 306, and into the dielectric region 304 and may respectively land on the metal silicide layers 338 and 340 of the photodetector structures 126a-126f. The contact structures 334 and 336 may extend into the dielectric region 308 and may land on the resonator heater structures 122a-122f.

The contact structures 332, 334, 338, and/or 340 may be formed in recesses that extend through the dielectric region 308, the etch stop layer 306, and/or the dielectric region 304. In some implementations, a pattern in a photoresist layer is used to etch the dielectric region 308, the etch stop layer 306, and/or the dielectric region 304 to form the recesses. In these implementations, a deposition tool may be used to form the photoresist layer on the dielectric region 308 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 308, the etch stop layer 306, and/or the dielectric region 304 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for forming the recesses based on a pattern.

A deposition tool may be used to deposit the contact structures 332, 334, 338, and/or 340 using a CVD technique, a PVD technique, an ALD technique, an electroplating technique, and/or another suitable deposition technique. The contact structures 332, 334, 338, and/or 340 may be deposited in one or more deposition operations. In some implementations, a seed layer is first deposited, and the contact structures 332, 334, 338, and/or 340 are deposited on the seed layer. In some implementations, a liner is first deposited, and the contact structures 332, 334, 338, and/or 340 are deposited on the liner. The liner may include an adhesion liner, a barrier liner, and/or another type of liner, and may include liner materials such as titanium nitride (TiN) and/or tantalum nitride (TaN), among other examples. In some implementations, a planarization tool is used to perform a planarization operation (e.g., a CMP operation) to planarize the contact structures 332, 334, 338, and/or 340 after the contact structures 332, 334, 338, and/or 340 are deposited.

As shown in FIG. 7M, another portion of the dielectric region 308 may be formed above the contact structures 332, 334, 338, and/or 340. A deposition tool may be used to deposit the other portion of the dielectric region 308 using a PVD technique, an ALD technique, a CVD technique, and/or another suitable deposition technique. The other portion of the dielectric region 308 may be formed in one or more deposition operations. In some implementations, a planarization tool is used to perform a planarization operation (e.g., a CMP operation) to planarize the other portion of the dielectric region 308 after the other portion of the dielectric region 308 is deposited.

As further shown in FIG. 7M, the metallization layers 336 may be formed in the dielectric region 308. Recesses may be formed in the dielectric region 308, and the metallization layers 336 may be formed in the recesses. One or more metallization layers 336 may be formed such that the one or more metallization layers 336 land on the contact structures 332 and/or 334 of the photodetector structures 126a-126f. Additionally and/or alternatively, one or more metallization layers 336 may be formed such that the one or more metallization layers 336 land on the contact structures 338 and/or 340 of the resonator heater structures 122a-122f.

In some implementations, a pattern in a photoresist layer is used to etch the dielectric region 308 to form the recesses. In these implementations, a deposition tool may be used to form the photoresist layer on the dielectric region 308 (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the dielectric region 308 based on the pattern to form the recesses. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric region 308 based on a pattern.

A deposition tool may be used to deposit the metallization layers 336 using a CVD technique, a PVD technique, an ALD technique, an electroplating technique, and/or another suitable deposition technique. The metallization layers 336 may be deposited in one or more deposition operations. In some implementations, a seed layer is first deposited, and the metallization layers 336 are deposited on the seed layer. In some implementations, a planarization tool is used to perform a planarization operation (e.g., a CMP operation) to planarize the metallization layers 336 after the metallization layers 336 are deposited.

As indicated above, FIGS. 7A-7M are provided as an example. Other examples may differ from what is described with regard to FIGS. 7A-7M.

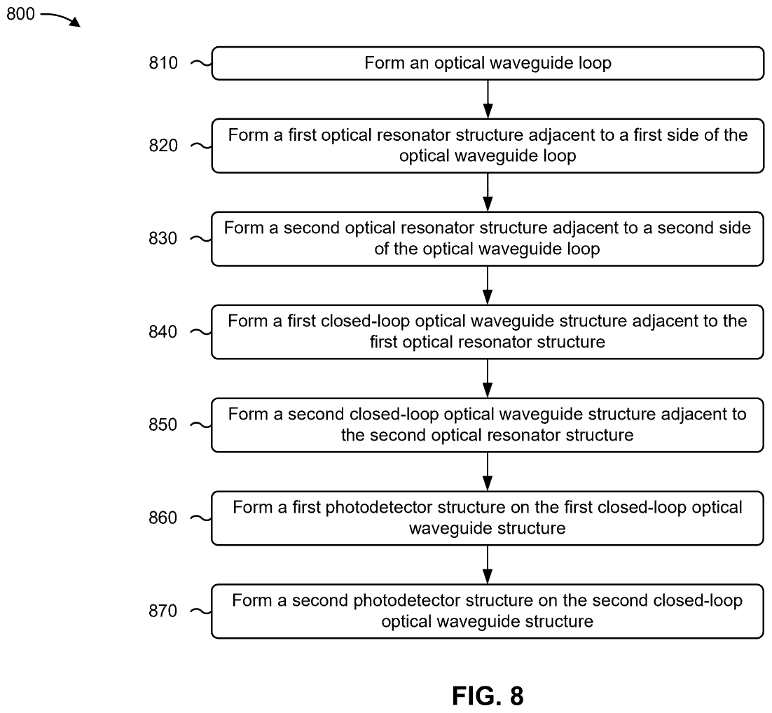

FIG. 8 is a flowchart of an example process 800 associated with forming a semiconductor photonics device described herein. In some implementations, one or more process blocks of FIG. 8 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 8, process 800 may include forming an optical waveguide loop (block 810). For example, one or more semiconductor processing tools may be used to form an optical waveguide loop (e.g., an optical waveguide loop 110), as described herein. In some implementations, the optical waveguide loop is open at a first end (e.g., an input end 116) of the optical waveguide loop and is closed at a second end (e.g., a loop end 114) of the optical waveguide loop.

As further shown in FIG. 8, process 800 may include forming a first optical resonator structure adjacent to a first side of the optical waveguide loop (block 820). For example, one or more semiconductor processing tools may be used to form a first optical resonator structure (e.g., an optical resonator structure 120a-120f) adjacent to a first side (e.g., a branch 112a) of the optical waveguide loop, as described herein.

As further shown in FIG. 8, process 800 may include forming a second optical resonator structure adjacent to a second side of the optical waveguide loop (block 830). For example, one or more semiconductor processing tools may be used to form a second optical resonator structure (e.g., an optical resonator structure 120a-120f) adjacent to a second side (e.g., a branch 112a) of the optical waveguide loop, as described herein.

As further shown in FIG. 8, process 800 may include forming a first closed-loop optical waveguide structure adjacent to the first optical resonator structure (block 840). For example, one or more semiconductor processing tools may be used to form a first closed-loop optical waveguide structure (e.g., a closed-loop optical waveguide structure 124a-124f) adjacent to the first optical resonator structure, as described herein.

As further shown in FIG. 8, process 800 may include forming a second closed-loop optical waveguide structure adjacent to the second optical resonator structure (block 850). For example, one or more semiconductor processing tools may be used to form a second closed-loop optical waveguide structure (e.g., a closed-loop optical waveguide structure 124a-124f) adjacent to the second optical resonator structure, as described herein.

As further shown in FIG. 8, process 800 may include forming a first photodetector structure on the first closed-loop optical waveguide structure (block 860). For example, one or more semiconductor processing tools may be used to form a first photodetector structure (e.g., a photodetector structure 126a-126f) on the first closed-loop optical waveguide structure, as described herein.

As further shown in FIG. 8, process 800 may include forming a second photodetector structure on the second closed-loop optical waveguide structure (block 870). For example, one or more semiconductor processing tools may be used to form a second photodetector structure (e.g., a photodetector structure 126a-126f) on the second closed-loop optical waveguide structure, as described herein.

Process 800 may include additional implementations, such as any single implementation or any combination of implementations described below and/or in connection with one or more other processes described elsewhere herein.

In a first implementation, forming the first closed-loop optical waveguide structure includes forming the first closed-loop optical waveguide structure such that the first optical resonator structure is located between the first side of the optical waveguide loop and the first closed-loop optical waveguide structure, and forming the second closed-loop optical waveguide structure includes forming the second closed-loop optical waveguide structure such that the second optical resonator structure is located between the second side of the optical waveguide loop and the second closed-loop optical waveguide structure.

In a second implementation, alone or in combination with the first implementation, forming the second closed-loop optical waveguide structure includes forming the second closed-loop optical waveguide structure closer to the second end of the optical waveguide loop than the first closed-loop optical waveguide structure, wherein a first length (e.g., a dimension D1-D6) of the second closed-loop optical waveguide structure is less than a second length (e.g., a dimension D1-D6) of the first closed-loop optical waveguide structure.

In a third implementation, alone or in combination with one or more of the first and second implementations, forming the optical waveguide loop, forming the first optical resonator structure, forming the first closed-loop optical waveguide structure, forming the second resonator structure, and forming the second closed-loop optical waveguide structure comprise forming the optical waveguide loop, forming the first optical resonator structure, forming the first closed-loop optical waveguide structure, forming the second resonator structure, and forming the second closed-loop optical waveguide structure from a same semiconductor layer 704 of a semiconductor photonics device 100.

In a fourth implementation, alone or in combination with one or more of the first through third implementations, process 800 includes forming a third optical resonator structure (e.g., an optical resonator structure 120a-120f) adjacent to the first of the optical waveguide loop and adjacent to the first optical resonator structure, forming a third closed-loop optical waveguide structure (e.g., a closed-loop optical waveguide structure 124a-124f) adjacent to the third optical resonator structure and adjacent to the first closed-loop optical waveguide structure, and forming a third photodetector structure (e.g., a photodetector structure 126a-126f) optically coupled to the third closed-loop optical waveguide structure.

In a fifth implementation, alone or in combination with one or more of the first through fourth implementations, forming the third closed-loop optical waveguide structure includes forming the third closed-loop optical waveguide structure closer to the second end of the optical waveguide loop than the first closed-loop optical waveguide structure, wherein a first length (e.g., a dimension D1-D6) of the third closed-loop optical waveguide structure is less than a second length (e.g., a dimension D1-D6) of the first closed-loop optical waveguide structure.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

In this way, a photonic integrated circuit of a semiconductor photonics device includes an optical demultiplexer circuit that is configured to demultiplex a plurality of polarized optical signals using the same set of photonics components. For example, a WDM optical signal may be split into two or more polarized optical signals, each carrying a plurality of data streams that are multiplexed onto different wavelength components. An optical resonator structure, an optical waveguide structure, and a photodetector structure of the optical demultiplexer circuit are configured to demultiplex a wavelength component from the two or more polarized optical signals, as opposed to having separate optical resonator structures for each of the two or more polarized optical signals. The two or more polarized optical signals may propagate along an optical waveguide loop in opposite directions toward the optical resonator structure and may optically couple to the waveguide structure through the optical resonator structure. The length of the optical waveguide structure, and the positioning of the photodetector structure along the optical waveguide structure, are selected such that the two or more polarized optical signals travel approximately a same distance to the photodetector structure such that the two or more polarized optical signals are synchronized at the photodetector structure.

As described in greater detail above, some implementations described herein provide a semiconductor photonics device. The semiconductor photonics device includes an optical splitter structure. The semiconductor photonics device includes an optical waveguide loop adjacent to the optical splitter structure. The semiconductor photonics device includes an optical resonator structure adjacent to the optical waveguide loop. The semiconductor photonics device includes a closed-loop optical waveguide structure adjacent to the optical resonator structure. The semiconductor photonics device includes a photodetector structure optically coupled to the closed-loop optical waveguide structure.

As described in greater detail above, some implementations described herein provide a semiconductor photonics device. The semiconductor photonics device includes an optical splitter structure. The semiconductor photonics device includes an optical waveguide loop, adjacent to the optical splitter structure, comprising, a first branch coupled to a first output of the optical splitter structure at a first end of the optical waveguide loop a second branch, coupled to a second output of the optical splitter structure at the first end of the optical waveguide loop, where the first branch and the second branch are coupled together at a second end of the optical waveguide loop opposing the first end. The semiconductor photonics device includes a first optical resonator structure adjacent to the first branch of the optical waveguide loop. The semiconductor photonics device includes a first closed-loop optical waveguide structure adjacent to the first optical resonator structure, where the first closed-loop optical waveguide structure has a first length. The semiconductor photonics device includes a first photodetector structure optically coupled to the first closed-loop optical waveguide structure. The semiconductor photonics device includes a second optical resonator structure adjacent to the first branch of the optical waveguide loop. The semiconductor photonics device includes a second closed-loop optical waveguide structure adjacent to the second optical resonator structure, where the second closed-loop optical waveguide structure has a second length that is different from the first length. The semiconductor photonics device includes a second photodetector structure optically coupled to the second closed-loop optical waveguide structure.

As described in greater detail above, some implementations described herein provide a method. The method includes forming an optical waveguide loop, where the optical waveguide loop is open at a first end of the optical waveguide loop and is closed at a second end of the optical waveguide loop. The method includes forming a first optical resonator structure adjacent to a first side of the optical waveguide loop. The method includes forming a second optical resonator structure adjacent to a second side of the optical waveguide loop. The method includes forming a first closed-loop optical waveguide structure adjacent to the first optical resonator structure. The method includes forming a second closed-loop optical waveguide structure adjacent to the second optical resonator structure. The method includes forming a first photodetector structure on the first closed-loop optical waveguide structure. The method includes forming a second photodetector structure on the second closed-loop optical waveguide structure.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
an optical splitter structure;
an optical waveguide loop adjacent to the optical splitter structure;
an optical resonator structure adjacent to the optical waveguide loop;
a closed-loop optical waveguide structure adjacent to the optical resonator structure; and
a photodetector structure optically coupled to the closed-loop optical waveguide structure.

2. The semiconductor photonics device of claim 1, wherein a first branch of the optical waveguide loop and a second branch of the optical waveguide loop are physically coupled together at a first end of the optical waveguide loop; and
wherein the first branch and the second branch are spaced apart and disconnected at a second end of the optical waveguide loop opposing the first end.

3. The semiconductor photonics device of claim 2, wherein a first optical propagation path along the first branch and along the closed-loop optical waveguide structure to the photodetector structure has a first distance,
wherein a second optical propagation path along the second branch, through the first end, along the first branch, and along the closed-loop optical waveguide structure to the photodetector structure has a second distance, and
wherein the first distance and the second distance are approximately equal.

4. The semiconductor photonics device of claim 2, wherein the first branch and the second branch are coupled to the optical splitter structure at the second end of the optical waveguide loop.

5. The semiconductor photonics device of claim 1, wherein the optical resonator structure is located outside a perimeter of the optical waveguide loop.

6. The semiconductor photonics device of claim 5, wherein the closed-loop optical waveguide structure is located outside the perimeter of the optical waveguide loop.

7. The semiconductor photonics device of claim 6, wherein the optical resonator structure is located between the optical waveguide loop and the closed-loop optical waveguide structure.

8. A semiconductor photonics device, comprising:
an optical splitter structure;
an optical waveguide loop, adjacent to the optical splitter structure, comprising:
a first branch coupled to a first output of the optical splitter structure at a first end of the optical waveguide loop; and
a second branch, coupled to a second output of the optical splitter structure at the first end of the optical waveguide loop,
wherein the first branch and the second branch are coupled together at a second end of the optical waveguide loop opposing the first end;
a first optical resonator structure adjacent to the first branch of the optical waveguide loop;
a first closed-loop optical waveguide structure adjacent to the first optical resonator structure,
wherein the first closed-loop optical waveguide structure has a first length;
a first photodetector structure optically coupled to the first closed-loop optical waveguide structure;
a second optical resonator structure adjacent to the first branch of the optical waveguide loop;
a second closed-loop optical waveguide structure adjacent to the second optical resonator structure,
wherein the second closed-loop optical waveguide structure has a second length that is
different from the first length; and
a second photodetector structure optically coupled to the second closed-loop optical waveguide structure.

9. The semiconductor photonics device of claim 8, wherein the first closed-loop optical waveguide structure is located closer to the first end of the optical waveguide loop than the second closed-loop optical waveguide structure; and
wherein the first length of the first closed-loop optical waveguide structure is greater than the second length of the second closed-loop optical waveguide structure.

10. The semiconductor photonics device of claim 8, further comprising:
a third optical resonator structure adjacent to the second branch of the optical waveguide loop;
a third closed-loop optical waveguide structure adjacent to the third optical resonator structure,
wherein the first closed-loop optical waveguide structure has a third length; and
a third photodetector structure optically coupled to the third closed-loop optical waveguide structure.

11. The semiconductor photonics device of claim 10, wherein the first closed-loop optical waveguide structure and the third closed-loop optical waveguide structure are located outside of a perimeter of the optical waveguide loop.

12. The semiconductor photonics device of claim 11, wherein the first length of the first closed-loop optical waveguide structure and the third length of the third closed-loop optical waveguide structure are approximately equal.

13. The semiconductor photonics device of claim 8, wherein the first closed-loop optical waveguide structure comprises:
a main section in which the first photodetector structure is located; and
one or more extension sections optically coupled to the main section.

14. The semiconductor photonics device of claim 13, wherein the second closed-loop optical waveguide structure comprises:
another main section in which the second photodetector structure is located; and
one or more other extension sections optically coupled to the other main section,
wherein a first quantity of the one or more extension sections of the first closed-loop optical waveguide structure, and a second quantity of the one or more other extension sections of the second closed-loop optical waveguide structure, are different quantities.

15. A method, comprising:
forming an optical waveguide loop,
wherein the optical waveguide loop is open at a first end of the optical waveguide loop and is closed at a second end of the optical waveguide loop;
forming a first optical resonator structure adjacent to a first side of the optical waveguide loop;
forming a second optical resonator structure adjacent to a second side of the optical waveguide loop;
forming a first closed-loop optical waveguide structure adjacent to the first optical resonator structure;
forming a second closed-loop optical waveguide structure adjacent to the second optical resonator structure;
forming a first photodetector structure on the first closed-loop optical waveguide structure; and
forming a second photodetector structure on the second closed-loop optical waveguide structure.

16. The method of claim 15, wherein forming the first closed-loop optical waveguide structure comprises:
forming the first closed-loop optical waveguide structure such that the first optical resonator structure is located between the first side of the optical waveguide loop and the first closed-loop optical waveguide structure; and
wherein forming the second closed-loop optical waveguide structure comprises:
forming the second closed-loop optical waveguide structure such that the second optical resonator structure is located between the second side of the optical waveguide loop and
the second closed-loop optical waveguide structure.

17. The method of claim 15, wherein forming the second closed-loop optical waveguide structure comprises:
forming the second closed-loop optical waveguide structure closer to the second end of the optical waveguide loop than the first closed-loop optical waveguide structure,
wherein a first length of the second closed-loop optical waveguide structure is less than a second length of the first closed-loop optical waveguide structure.

18. The method of claim 15, wherein forming the optical waveguide loop, forming the first optical resonator structure, forming the first closed-loop optical waveguide structure, forming the second resonator structure, and forming the second closed-loop optical waveguide structure comprise:
forming the optical waveguide loop, forming the first optical resonator structure, forming the first closed-loop optical waveguide structure, forming the second resonator structure, and forming the second closed-loop optical waveguide structure from a same semiconductor layer of a semiconductor photonics device.

19. The method of claim 15, further comprising:
forming a third optical resonator structure adjacent to the first side of the optical waveguide loop and adjacent to the first optical resonator structure;
forming a third closed-loop optical waveguide structure adjacent to the third optical resonator structure and adjacent to the first closed-loop optical waveguide structure; and
forming a third photodetector structure optically coupled to the third closed-loop optical waveguide structure.

20. The method of claim 19, wherein forming the third closed-loop optical waveguide structure comprises:
forming the third closed-loop optical waveguide structure closer to the second end of the optical waveguide loop than the first closed-loop optical waveguide structure,
wherein a first length of the third closed-loop optical waveguide structure is less than a second length of the first closed-loop optical waveguide structure.
